(19) United States
(12) Patent Application Publication
(10) Pub. No.: US 2014/0149249 A1
(43) Pub. Date: May 29, 2014

(54) SYSTEMS AND METHODS FOR MANAGING AND/OR RECOMMENDING THIRD PARTY PRODUCTS AND SERVICES PROVIDED TO A USER

(71) Applicant: Allconnect, Inc., Atlanta, GA (US)

(72) Inventors: Glenn R. GOAD, Cumming, GA (US); Kamesh Chander Tumsi DAYAKAR, Atlanta, GA (US)

(73) Assignee: Allconnect, Inc., Atlanta, GA (US)

(21) Appl. No.: 14/087,932

(22) Filed: Nov. 22, 2013

Related U.S. Application Data
(63) Continuation of application No. 12/779,710, filed on May 13, 2010, now abandoned.
Application No. 12/779,710 is a continuation-in-part of application No. 12/754,930, filed on Apr. 6, 2010, now Pat. No. 8,433,617.
Application No. 12/754,930 is a continuation-in-part of application No. 12/634,345, filed on Dec. 9, 2009, now Pat. No. 8,346,624.

(51) Int. Cl. G06Q 30/06

(52) U.S. Cl. CPC G06Q 30/0631
USPC 705/26.7

(57) ABSTRACT

Systems and methods are described for an electronic services management system that enables a user to manage all or many of his or her third party products and services from one electronic platform. Specifically, the system includes operative connections to service provider systems so as to track customer usage of various third party products and services, and thus provide the user with a consolidated view of the user's products and services and enable the user to track usage and expense of the services, compare the expense to predetermined budget amounts, compare the usage to other users, etc. Additionally, the services management system recommends personalized product or service offerings to users based on the users' preferences and specific service usage. Further, the system provides alerts to the users when certain usage or expenditure thresholds are reached, when payments become due, or when new offers, deals, or service promotions become available.

### CROSS REFERENCE TO RELATED APPLICATIONS

This application is a continuation-in-part of and claims priority to and benefit of U.S. patent application Ser. No. 12/754,930, filed Apr. 6, 2010, entitled “Systems and Methods for Identifying Third Party Products and Services Available at a Geographic Location”, by Glenn R. Goad et al., which is a continuation-in-part of U.S. patent application Ser. No. 12/634,345, filed Dec. 9, 2009, entitled “Systems and Methods for Recommending Third Party Products and Services”, by Glenn R. Goad et al., both of which are hereby incorporated by reference.

### TECHNICAL FIELD

The present disclosure relates generally to management of products and services, and more particularly to electronic management and recommendation of products and services provided by third parties to consumers via a product and service management portal.

### BACKGROUND

Residents of any property typically utilize multiple third party utility services or products such as electricity, water, waste-disposal, Internet, television, cable, home security, home warranty, telephone services, and a variety of other products and services. These utility services are generally provided by a host of service providers, each with their own taxes, conditions, payment due dates, service plans, web portals, etc., which makes management of these services by residents a very cumbersome task. As a result, residents often pay more money than necessary for these services, as the residents may be unaware of service plans or providers more suitable to their needs. Also, even if product and service users are aware of better options or plans for their home services, the users often do not switch to the better plans because of the hassle and time commitment associated with disconnecting current service, registering for the new product or service, establishing a payment mechanism for the new service, etc.

Further, even when additional or better product or service offerings are unavailable to a given user or resident (e.g., there is only one service provider for a given service, only a limited number of plans are available at a user's geographical location, or the user is already utilizing the most optimal service plan), the user may wish to use that given service in the most efficient manner possible. However, it can be difficult to track, in virtually real time, usage of or expenditure for a given service during a billing cycle for the service. Often, users must wait until they receive their monthly or periodic bills to determine their service usage for that billing period. Even if users have the ability to track product or service usage on an ongoing basis (e.g., via their service provider's web portal), continuous tracking of usage of a variety of services across many service providers' online systems can be cumbersome and time-consuming. For example, a given user may wish to know when she exceeds her mobile phone minutes limit for her mobile phone plan in a given month so that she can curb use of her phone for the remainder of the month. However, unless the user continuously monitors her phone usage by systematically checking with her mobile phone provider, then the user may have no idea if she is within her minutes limit or not (and thus is or is not in danger of incurring overage fees).

Moreover, with recent increases in the practice of environmentally-conscious behavior, many home services users desire to reduce or modify their use of such services so as to cause less negative impact on the environment. Currently, general information and advice is available to assist residents in reducing their use of utilities and other services (e.g., lower the thermostat in winter, take quicker showers to reduce water usage, etc.), but there is typically no way that a resident can obtain personalized and focused information regarding the resident's specific use of home services at the resident's specific address or location. Further, and for example, residents may be willing to spend additional upfront funds on the purchase of an energy efficient appliance, as long as the reduced energy costs associated with the appliance warrant the additional expenditure. Currently, residents have no way of determining whether, based on their personalized energy and appliance usage, the purchase of a new energy efficient appliance will pay off in the long run.

Additionally, many utilities and home services users wish to simply track their usage of their home services and products, identify the costs associated with that usage, compare those costs to the users' monthly or periodic budgets for the products or services, compare their usage to others in their community or nationally, etc. However, there is currently no available system or technology that enables a user to track usage of and expenditure for third party provided home services and utilities, compare that usage to other users, and take actions (e.g., reduce usage, purchase different product or service plans, disconnect old services, etc.) to save money based on that usage information.

Therefore, there exists a long-felt but unresolved need for a system or method that interacts with a user to combine and analyze various sources of disparate information relating to third party products and services offered at a user's address or geographic location, and suggest optimal products or services to the user based on the collected information to enable the user to select, purchase, and/or transfer the most appropriate product(s) or service(s) that fit his or her needs. There is a further need for a system or method that assists users in the overall management of their third party products and services in the most usage- and cost-efficient manner, provides energy saving recommendations to users, and proactively notifies users of irregularities in monthly product or service expenditures before bill generation or about new promotions, plans, or sales that can help reduce overall expenditure. Moreover, there exists a need for a system that tracks usage of third party products and services by users for user review and analysis, enables consolidation of payment and management of multiple products and services offered by disparate providers in one conveniently-accessible location, and provides updated recommendations to users based on the users' previous responses to previously-presented recommendations.

### BRIEF SUMMARY

Briefly described, and according to one embodiment, the present disclosure describes a computer implemented method for optimizing one or more home services provided by multiple third party service providers. Initially, home services information is obtained and stored in a customer database. Next, information pertaining to at least one characterizing parameter of a particular third party service provided by a particular third party service provider is retrieved directly from third party service providers and stored in a service database at predefined time intervals. Based on the homes services information and the characterizing parameters, management information relating to the user's utilization of a third party service is computed and presented to the user. Finally, the method provides service optimization information to the user based on the computed management information.

Another embodiment of the present disclosure presents a system for optimizing one or more home services provided by multiple third party service providers. The system includes a processor, a network interface for communication with users and the third party service providers, and a memory. The memory further includes an input module for obtaining home services information, and a customer database for storing the home services information. Further, a third party interface module retrieves, at predefined time intervals, information pertaining to at least one characterizing parameter of a particular third party service provided by a particular third party service provider directly from third party service providers. The memory further includes a service database for storing the at least one characterizing parameter, and an analyzer for computing management information relating to the user's utilization of a third party service. A recommendation module provides service optimization information to the user based on the computed management information.

Certain embodiments of the disclosure may provide various technical advantages. For example, certain embodiments may provide users with a comprehensive solution for identifying home services best suited for them. Further, other embodiments may provide users with personalized recommendations taking into consideration several factors such as user preferences, demographic data, past usage trends, service provider databases, credit information, and so on.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel disclosure concepts.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment. The drawings are illustrative in nature and are not necessarily drawn to scale.

FIG. 1 is an architecture diagram illustrating an exemplary system for electronic acquisition of products and services provided by an embodiment of an order facilitation service.

FIG. 2 is a flowchart illustrating an exemplary method for electronic acquisition of products and services provided by an order facilitation service according to an embodiment of the present system.

FIG. 3 illustrates an exemplary user identification screen according to an embodiment of the present system.

FIG. 4 illustrates an exemplary user information retrieval screen according to an embodiment of the present system.

FIG. 5 illustrates an exemplary listing of product and service types available at a given address according to an embodiment of the present system.

FIG. 6 is a screenshot of an exemplary list of ordered recommendations for products and services suggested to a user for use at the user's geographic location according to an embodiment of the present system.

FIG. 7 illustrates an exemplary list of available service plans at a geographical location according to an embodiment of the present system.

FIG. 8 illustrates an exemplary provider integration page according to an embodiment of the present system.

FIG. 9 illustrates an exemplary acquisition summary report listing products and/or services purchased by a user of an embodiment of the present system.

FIG. 10 illustrates an exemplary advisor engine architecture according to one embodiment of the present system.

FIG. 11 illustrates an exemplary products and services database schema according to one embodiment of the present system.

FIG. 12 illustrates an exemplary user information database schema according to one embodiment of the present system.

FIG. 13 illustrates an exemplary address database schema according to one embodiment of the present system.

FIG. 14 is a flowchart illustrating an exemplary method for providing services management and/or optimization information to a user according to one embodiment of the present system.

FIG. 15 illustrates an exemplary dwelling/location information request screenshot according to one embodiment of the present system.

FIG. 16 illustrates an exemplary account selection/activation screen according to one embodiment of the present system.

FIG. 17 illustrates an exemplary user preferences and service configuration information retrieval screen shot for exemplary “bundled” services according to one embodiment of the present system.

FIG. 18 illustrates an exemplary user preferences and service configuration information retrieval screen shot for exemplary television services according to one embodiment of the present system.

FIG. 19 illustrates an exemplary user preferences and service configuration information retrieval screen shot for exemplary Internet services according to one embodiment of the present system.

FIG. 20 illustrates an exemplary user preferences and service configuration information retrieval screen shot for exemplary electricity services according to one embodiment of the present system.

FIG. 21 illustrates an exemplary automatic configuration information integration screen according to one embodiment of the present system.

FIG. 22 illustrates an exemplary services management information screenshot—I, according to one embodiment of the present system.

FIG. 23 illustrates an exemplary services management information screenshot—II, according to one embodiment of the present system.

FIG. 24 illustrates an exemplary services management information screenshot—III, according to one embodiment of the present system.

FIG. 25 illustrates an exemplary services optimization information screenshot—I, according to one embodiment of the present system.

FIG. 26 illustrates an exemplary services optimization information screenshot—II, according to one embodiment of the present system.

FIG. 27 illustrates an exemplary services optimization information screenshot—III, according to one embodiment of the present system.

FIG. 28 illustrates an exemplary alerts/notifications screenshot according to one embodiment of the present system.

FIG. 29 is a flow chart illustrating an exemplary method for generating notifications according to one embodiment of the present system.

FIG. 30 is a flow chart illustrating an exemplary method for effectuating product or service bill payments according to one embodiment of the present system.

### DETAILED DESCRIPTION

Prior to a detailed description of the disclosure, the following definitions are provided as an aid to understanding the subject matter and terminology of aspects of the present systems and methods, are exemplary, and not necessarily limiting of the aspects of the systems and methods, which are expressed in the claims. Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### DEFINITIONS/GLOSSARY

Advisor engine: system component or module as described in this document, that provides recommendations to system users regarding suggested or optimal products or services that may fit the users' needs or preferences, tracks usage of third party products and services by users and provides information relating to usage of such products and services to users, generates notifications when new product or service offerings become available, when product or service usage or cost thresholds are reached, and performs various other functionalities as described herein. Generally synonymous with services management system.

Analyzer: algorithm, software module, processor, or other system component that monitors and analyzes a user's usage and expense of products and services, and provides to a user data or information that assists a user in managing and optimizing the user's products or services. Outputs generally include services management information.

Capabilities: for product and service providers, the requirements and/or physical criteria required to effectuate a given service at a particular address location. Examples include specific connections (e.g., cable, telephone, etc.), specific hardware (e.g., satellite dish, high-speed modem, security system, etc.), specific associated services (e.g., on recycling pickup route), and other similar requirements. For a user's address or geographic location, capabilities comprise the available connections, hardware, or other facilities/functionality available at the address to receive products and/or services.

Characterizing Parameter: a detail or feature associated with a product or service that defines or relates to the product or service offering. Examples include, but are not limited to, the product or service type, geographic areas serviced, basic or standard features included in the service offering, optional features included, the price, special requirements to effectuate service, product popularity and/or ratings, and other similar types of information. Generally synonymous with service characterizing parameter.

Input Module: algorithm, software module, processor, or other system component that receives information of a user.

Order Facilitation System: a system constructed as described in this document, that facilitates ordering by users of third party products and services, preferably offered to a geographic location. Generally synonymous with order facilitation service, facilitation system, facilitation service, and facilitation engine.

Product and/or Service Configuration Information: details and information associated with a user's products or services. Examples include, but are not limited to, the product or service provider that provides the particular service, the particular product or service plan/offering, the cost associated with the particular service plan, the features or user preferences that are included in the plan, the default payment method the user utilizes to pay bills associated with the product or service offering, and other similar types of information.

Product and/or Service Preference Information: features or options associated with a given product or service that a user desires in a new service offering and/or is currently included in the user's current service offering. Generally synonymous with user preferences or user preference information.

Product and/or Service Provider: an entity, company, or person that provides products and/or services to a user at the user's geographic location or address.

Product and/or Service Usage Information: information relating to a user's use of a given product or service. Generally may be obtained in real-time within a period (e.g., monthly) billing cycle, or averaged over many billing cycles, etc. Generally may be obtained directly from a product or service provider, or received from a user, etc.

Recommendation Engine: algorithm, software module, processor, or other system component that provides recommendations to system users regarding personalized product and service recommendations for new or different product or service offerings based on the user's service usage patterns and service preferences, tips and tricks for optimizing usage of the user's products or services, and other similar recommendations. Outputs generally include services optimization information.

Serviceability: determination of particular product and service providers that provide services to a given geographic location, the specific products and services offered to the location by those product and service providers, and capability of the given location to accept or utilize the specific products and services.

Serviceability Information: data and information relating to the serviceability of particular products and services offered by particular product and service providers at a particular geographic location.

Services Management Information: data or information that assists a user in monitoring or managing the user's products or services, including information corresponding to the usage or expense of such products or services over a given time period, comparisons of a given user's usage or expense related to such services to other system users, analytics and information relating to identified trends or patterns in service usage, and other similar types of information.

Services Optimization Information: data or information relating to optimizing the efficiency, usage, expense, etc., of a user's products or services, including personalized product and service recommendations for new or different product or service offerings based on the user's service usage patterns and/or service preferences, tips and tricks for optimizing usage of the user's products or services, suggestions for reducing energy usage, and other similar types of information.

Services Management System: see advisor engine.

Third party products and/or services: products and/or services provided by a third party (e.g., utility provider) to the address or geographic location of a user. Generally include electricity, natural gas, satellite television, cable television, wireless telephone, landline telephone, Internet, home security, home insurance, home warranty, newspaper delivery, home cleaning service, moving service, dry-cleaning, trash pickup, pest control, and other similar products and services. Generally synonymous with products and/or services, products, services, and home services. As used herein, the terms “product” and “service” are considered synonymous and interchangeable.

User: a person or entity that utilizes embodiments of the presently-described systems and methods. Generally includes a resident, occupant, or business-owner of an address or geographic location, a customer service representative (CSR), or other similar user. Generally synonymous with resident, consumer, or customer.

### System Overview

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Embodiments of the present disclosure generally relate to aspects of an electronic (e.g., Internet-accessible) system (e.g., an order facilitation service) that facilitates acquisition and management of geographically-determined third party products and services to consumers. According to one embodiment, the system includes operative connections to a number of product and service providers, and coordinates and offers products and services of those product and service providers to users of the system. For example, if a user relocates his or her residence from Dallas to Atlanta, the user can access the electronic system (e.g., via the Internet, or via a phone call to a call center that accesses the electronic system) to arrange for disconnection of existing residential or business services such as telephone, cable television, satellite television, Internet, trash pickup, security, electricity, gas, pest control, other utilities, and so on, and reconnection of similar services in Atlanta. Alternatively, if a user simply wishes to add a new product or service to his or her existing location, or change an existing service, he or she can do so via the electronic order facilitation system. In this way, a user is able to transfer existing products and services, order new products and services, or cancel products and services offered by a plurality of different product and service providers from one central facilitation system (described in greater detail below).

Further, according to one aspect, the electronic order facilitation system includes a serviceability engine that determines particular product and service plans offered by particular product and service providers at a particular geographic location based on disparate sources of information. Specifically, the system includes operative connections to service provider systems and other external data sources (e.g., tax records, U.S. Postal Service, census data, user-entered data) that enables the serviceability engine to identify products and services available to a given geographic location based on specifics associated with the service providers (e.g., only provides service in Atlanta), capability requirements associated with the products and services (e.g., requires recycling pickup service), and capabilities available at the given geographic location (e.g., existing satellite connection). The serviceability engine also parses and normalizes disparate address information to enable efficient processing of that information and accurate retrieval of available products and services. According to one aspect, the products and services that are determined to be available at a given location are used as a baseline input by the facilitation system to determine the most optimal products and services for a given user based on the user's preferences, demographics, affordability of the services, etc. As used herein, “serviceability” refers to determination of particular product and service providers that provide services to a given geographic location, the specific products and services offered to the location by those product and service providers, and capability of the given location to accept or utilize the specific products and services.

According to an additional aspect, the electronic order facilitation system provides a services management system and/or portal (e.g., advisor engine) that enables each user to manage all or many of his or her third party products and services from one electronic platform. Specifically, the system includes operative connections to service provider systems so as to track customer usage of various third party products and services. This usage information is utilized to provide the user via the services management system with a consolidated view of the user's products and services and enable the user to track usage and expense of the services, compare the expense to predetermined budget amounts, compare the usage to other users locally and nationally, etc. Additionally, the services management system provides alerts to the users (e.g., via email, mobile phone, text (SMS) message, etc.) when certain usage or expenditure thresholds are reached (e.g., mobile phone minutes overage, pay-per-view movie orders, etc.), when payments become due, or when new offers, deals, or service promotions become available, etc. Further, the system allows for consolidated bill payment from one convenient location.

According to another aspect, the electronic order facilitation system receives data from a variety of different sources (e.g., publicly-available census data, product and service data provided by product and service providers, stored data based on previous user orders, user-entered data, etc.), and analyzes that data according to predetermined rules, factors, etc., to provide a user with rankings or suggestions of optimal product and service offerings that are tailored to the specific user's needs and preferences. For example, based on a given user's mobile phone plan with service provider X, the system may identify a new plan offered by service provider Y that is less expensive than the user's current plan, but includes all of the same features as the current plan. Accordingly, the system may provide a suggestion to the user to switch plans to the new plan offered by provider Y. This recommendation may be provided via an alert, or simply displayed on the user's portal for viewing the next time the user logs in to the system, or may be presented to the user via a call center representative during a move of the user's residence, etc. Correspondingly, the present system provides a mechanism for enabling the user to automatically transfer his or her mobile phone service to the newly-offered plan. According to one aspect, the system automatically selects the most optimal or most appropriate (e.g., highest ranked) product or service for each product or service type of which the user is interested, and suggests or automatically populates a user's order with the selected products or services.

According to a further aspect, over time as users order numerous products and services via the electronic system (or do not order suggested products or services), the system stores information relating to those orders (or non-orders), and subsequently provides that order history information to third party product and service providers for further use. Specifically, and for example, the electronic order facilitation service may provide order history information, user preference information, product or service rankings, popularity information of certain products or services, and other similar types of information to the third party service providers, enabling the providers to analyze their products and services based on the received information to improve the quality of their products and services, sales, and profit margins. For example, in one geographical location such as Atlanta, the electronic system may determine that most users prefer Telco's Internet service as a result of cost benefits offered and because Telco provides excellent customer support service. Other Internet service providers can analyze Telco's service plans along with their own service plans to optimize their plans for better customer satisfaction, and in turn higher sales.

Described immediately below is an overview of one embodiment of the order facilitation system for facilitating the ordering, ranking, and recommendation of third party products and services offered to consumers. Thereafter, the “Exemplary Advisor Engine” section (and the sections that follow) describe the functionality of at least one embodiment of an advisor engine (i.e., services management system) within the order facilitation system for tracking usage of third party services provided to users, displaying information to users via a portal regarding that service usage, recommending certain service plans or options to users based on specific usage patterns and services of the users, providing alerts to the users in various forms as predetermined events (e.g., exceeding service usage thresholds, new service promotions, etc.) occur, enabling bill payment for services, activation or disconnection of particular services, and a host of other functions relating to product and service management.

### Exemplary Product and Service Ordering System

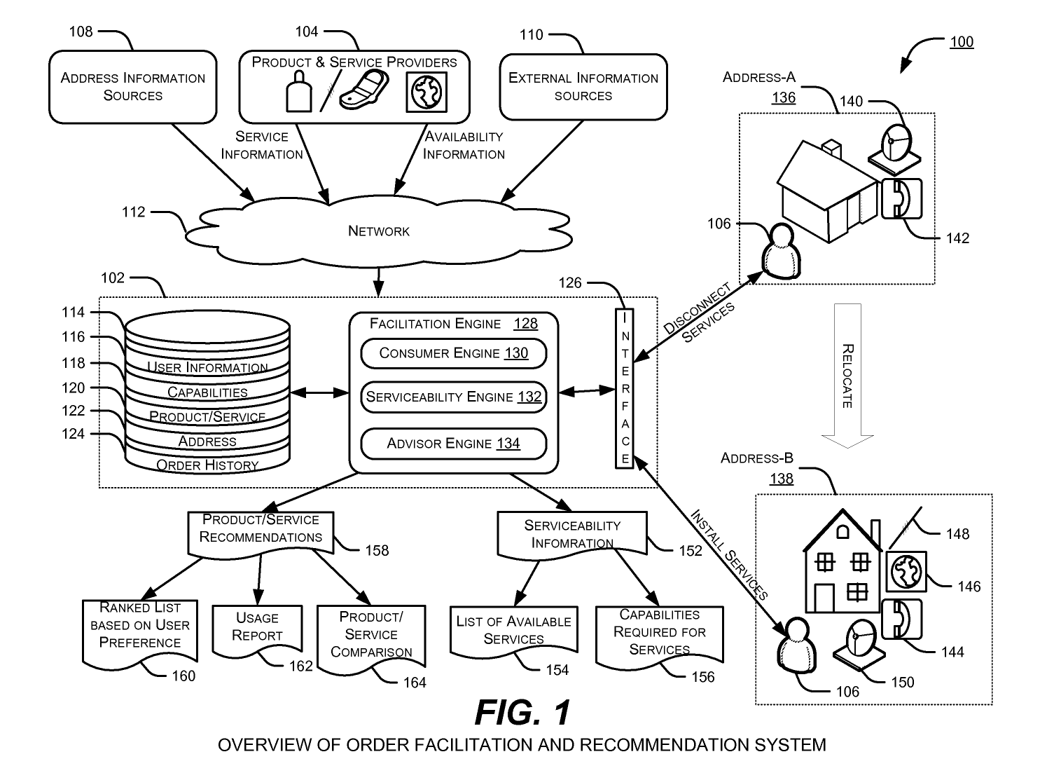

Turning now to the figures, FIG. 1 illustrates an embodiment of an electronic system 100 for recommending and facilitating the ordering of third party products and services provided to users (i.e., an order facilitation and recommendation service), and enabling user management of those products and services, as described in detail herein. As shown, the electronic system 100 includes a computing system 102 operatively coupled to one or more third party product and service provider(s) 104, user(s) 106, address or location information source(s) 108, and other external information source(s) 110 through a network (e.g., Internet) 112. Although not specifically shown, it will be understood by one of ordinary skill in the art that, according to one embodiment, users 106 access the computing system 102 via the network 112, or via a call center, etc. For purposes of the present disclosure, the term “user” is generally synonymous with “customer” or “consumer”.

As shown, the computing system 102 maintains one or more database(s) 114 that store information from the sources 104, 108, 110. The databases 114 may include a customer (or user) information database 116, a capabilities database 118, a products and services database 120, an address database 122, and an order history database 124. Generally, the computing system 102 retrieves information from the sources 104, 108, 110 and populates the retrieved information in the databases, based on system requirements. As will be understood, these databases may be updated in real time or on an intermittent basis. As will be further understood, the specific databases shown and described are intended to be illustrative only, and actual embodiments of the present system include various database structures, schemas, etc.

Depending on the particular embodiment, the network 112 may be the Internet, providing interaction capabilities between the various sources and the computing system 102, a private network (such as a VPN), a PSTN system (providing call center capabilities), a mobile phone network, or a combination of these networks. For example, the computing system 102 can have both Internet connectivity as well as call center capabilities to service users. Some users may prefer to use the Internet for service acquisition, while other users, who may not be as adept or familiar with the Internet, may prefer to use the call center facility (not shown). According to one embodiment, the call center employs customer service representatives (CSRs) that interact with the user, obtain information from the user, and provide information (e.g., suggested products and services) to the user to assist the user in obtaining the requested products and services and/or managing existing products and services.

The user information database 116 generally includes information pertaining to each user 106, such as the user's name, a user identification number, preferences and details associated with that user, the user's purchase history of products and services ordered through the computing system 102, current, future, and previous address information (if available), financial information (e.g., credit history), and other similar types of information. This information may be retrieved from a variety of sources, such as the user 106, previously stored information in the computing system 102, financial institutions, publicly available data sources, or other information sources known in the art. For example, a user's purchase history can be retrieved from the computing system 102 every time an order is placed via the order history database 124. Financial information, on the other hand, may be obtained from either the user 106, or some financial institutions. It will be understood that other information sources may also be used to obtain user related information—for example, census information can be utilized to gather information such as the number of family members, family income, and other user-related information.

The address database 122 may include extensive information about each user's geographic location(s) (e.g., address or addresses), or all of the physical addresses in a given geographic area. The information relating to the addresses stored in the address database 122 may include address characteristics (such as whether the location is a business address or a household, an apartment or a home, etc.), the size of the residence, the floor plan, the number of rooms, the size of a lot, or other similar information. The address information also may include information relating to the product and service capabilities at a given address, such as whether the address is pre-wired for certain types of services, includes pre-existing home security or satellite systems, is located on a recycling pickup route, etc. This information may be retrieved from the users 106 or the address information source(s) 108, such as real estate sources, city plans blueprints, census data, product or service providers, city authorities, tax records, or any other known sources.

Similarly, information pertaining to third party products and services is stored in the products and services database 120. This information may be directly retrieved from the third party product and service providers 104 or from other external information sources 110 to populate the database. For example, the products and services database 120 may include information about the products and services offered (e.g., prices of plans, plan specifics, features, etc.), geographical areas serviced, special offers or promotions from the service providers 104, types of hookups, connections, or other address capabilities required to utilize the service, and other similar information. Further, information such as product or service popularity, user ratings, order history of each product or service, product reviews, etc., may be stored in the products and services database 120, or may be retrieved from other external sources 110 or other system databases (e.g., the order history database 124) that store details of orders made through an embodiment of the computing system 102.

Still referring to FIG. 1, the capabilities database 118 uses information from the products and services database 120, the address database 122, the service providers 104, and the users 106 to build a cross-referenced database of various capabilities required for different products and services stored in the products and services database 120, and their potential for availability at the addresses in the address database 122. For example, if a certain Internet provider provides a DSL connection, then as an entry or data item for that service provider, the capabilities database 118 may store a “cable connection required” identifier. As a further example, if capability information is available for an address, the capabilities database 118 maintains a list of capabilities corresponding to that address, such as “telephone connection present,” or “no gas connection”. As recited previously, some or all of this information also may be stored in the address database 122, and thus the capabilities database can retrieve the information from there. Alternatively, certain products or services may not be available in certain areas, and thus the capabilities information for those products and services will indicate that those products and services cannot be ordered for those areas. Thus, each product or service, user address, etc., may be associated with predetermine rules or criteria that dictate an availability for a given product or service in a particular area or for a particular address. Further, as will be understood, this information may be updated on a real-time or intermittent basis from product or service providers 104 or other information sources 108, 110.

The capabilities information stored in the capabilities database 118 is useful to determine the most appropriate product or service for a user 106. For example, if a user's household already includes a telephone connection, it may be advisable to select an Internet service provider that provides telephone cable connection, rather than a service provider that provides only LAN-based connections. Or, if a home is pre-wired for a security system, then the facilitation system 100 can recommend that the user subscribe for home security service, as the initial installation cost associated with such service will be unnecessary. This capabilities information may be retrieved from address sources 108, service providers 104, from the users 106 directly, or from other sources as will occur to one of ordinary skill in the art.

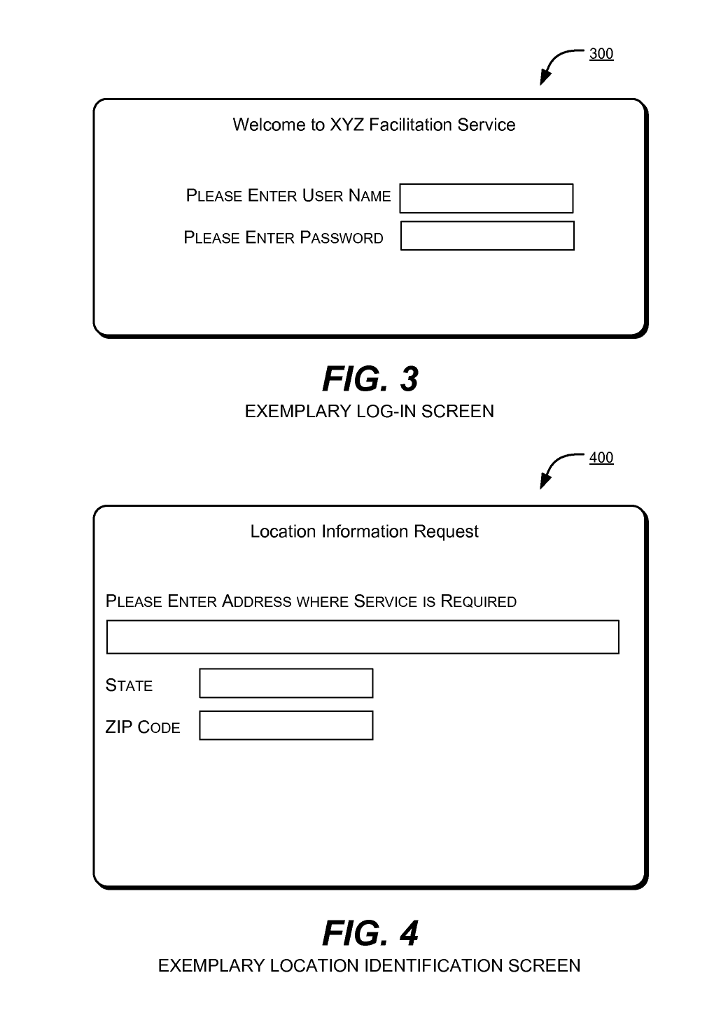

Still referring to FIG. 1, in addition to the databases, one embodiment of the computing system 102 includes a user interface 126 and a facilitation engine or module 128. Generally, the user interface 126 comprises a graphical user interface (GUI) that allows users 106 to access the computing system 102, input information and details into the system regarding the user or the user's address (e.g., user preferences, address information, a customer identification number, etc.), and request, review, and order products and services. For example, if a user 106 desires to acquire an electricity connection at his or her home, the user interface 126 may display an ordered list of electricity connection providers, along with their service plans, based on analysis of disparate information. Additionally, one aspect of the user interface allows for management of services at the user's address, tracking of service costs and bills as compared to previous billing cycles or other users of the services in similar or different geographic areas, provision of helpful cost-savings or energy efficient service usage information, etc. According to one embodiment, rather than the user accessing the user interface 126 via the network 112, the user may contact a call center and a customer representative may assist the user in ordering various products and services (e.g., a user interface may be displayed to the call center representative). Example screen shots illustrating various user interface screens are shown in FIGS. 3-9 (and described in greater detail below).

According to one embodiment, the facilitation engine 128 includes algorithm(s) or other system components that enable a user to review, transfer, cancel, purchase, track usage and expense of, or otherwise manage third party products and services. Generally, the facilitation module 128 interacts with databases 114 and other information sources (described herein and as will occur to one of ordinary skill in the art) to identify third party products and services available to a given user based on the user's geographic location, and enable a user to select and order such products and services directly (i.e., without having to contact the third party product and service providers individually). Further, the facilitation module 128 may aid users in managing the acquired services by providing expenditure analyses, generating alerts when new or less expensive product or service plans become available, introducing new money saver promotions related to products or services, etc.

In the embodiment shown in FIG. 1, the facilitation module 128 includes one or more sub-engine(s) or module(s) that facilitate its third party product and service recommendation, management, and order functionality. As seen here, the facilitation engine 128 includes a consumer engine 130, a serviceability engine 132, and an advisor engine 134. Operation of the engines is briefly described below, and in more detail in the following sections.

According to one aspect, the consumer engine 130 enables recommendation of the most suitable products and services and/or service providers 104 to the users 106 based on user preferences, profitability goals, popularity of products or services, etc. Specifically, the consumer engine 130 generates an ordered list of products or services based on user preferences, user location, user information, product and service information, etc., by performing extensive analysis and calculations on this and other information from the customer information database 116, the capabilities database 118, the products and services database 120, the address database 122, or the order history database 124. The ordered or ranked list is intended to represent products or services that a given user is most inclined to purchase and/or most fits the user's needs. This ranked list of services can be displayed to a user for selection, viewing, and ordering, or similarly displayed to a customer service representative that relays the information to a consumer. Alternatively, the most optimal or most highly-recommended services can be extracted and displayed to a user, or automatically ordered via the order facilitation system 100.

In one aspect, the serviceability engine 132 determines the availability of products and services at a particular address/locality utilizing stored data from the products and services database 120 or utilizes real time data provided directly from the service providers 104. To this end, one embodiment of the serviceability engine 132 utilizes information from the user 106, such as an acceptable service address, dwelling type, and user identification. Further, the serviceability engine 132 generally uses data from the capabilities database 118 and address database 122 to determine the peripheral or additional requirements for a given service and to ascertain whether those capabilities are present and/or available at the user's address.

According to one aspect, the advisor engine 134 provides users with up-to-date and personalized information and/or advice on their home services such as electricity, gas, satellite television, cable television, phone, Internet, home security, insurance, home warranty, and other similar products and services. The advisor engine 134 provides recommendations to users regarding new or different product or service options based on a variety of factors such as personalized service usage trends, current product or service costs, available product or service options, competitive landscape, user experience based on customer reviews, and other similar factors. Users 106 can order or purchase new or different product or service plans based on the provided recommendations. In addition, the advisor engine 134 allows users to manage their home services, view their usage trends compared to other users or their own previous usage, plan budgets for future usage, and track expenditure versus budget for all of their home services.

Additionally, one embodiment of the advisor engine 134 also provides capabilities of setting up alerts for specific events such as when new deals are offered by product and service providers, when pay-per-view or movie-ordering thresholds are reached within a user's home, when mobile phone minutes usage reaches or exceeds a given threshold, etc. As will be understood and appreciated, these alerts can be provided via varying delivery mechanisms such as text (SMS) message, email, phone, and so on. To provide these functionalities, the advisor engine 134 utilizes information from information sources 104, 108, 110, and the databases 114, and it conducts extensive analysis and calculations on this data. The information may be provided to the users 106 in the form of usage reports, graphs, charts, product comparisons, and other such report formats. According to various embodiments, the advisor engine 134 also enables product or service bill pay, provision of “green” tips for energy-efficient service usage, and a host of other functionalities. Further details and functionality associated with embodiments of the advisor engine 134 are described in greater detail below.

Additionally, as will be understood, the facilitation module 128 includes other engines, modules, and functionalities not described herein as will occur to one of ordinary skill in the art. Further, the electronic system 100 is not intended to be limited by the specific information sources, databases, engines, and other components shown and described herein. As will be understood and appreciated, the architecture of the electronic system 100 may vary as needed and as will occur to one of ordinary skill in the art.

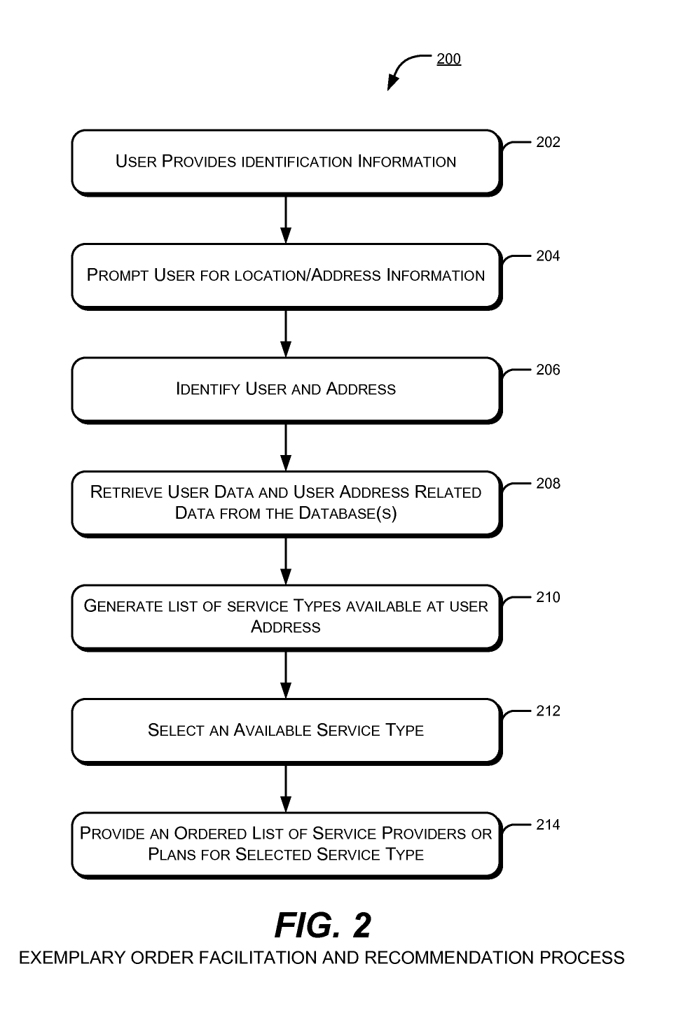

FIG. 2 illustrates an exemplary, high-level order facilitation and recommendation process 200 according to one embodiment of the order facilitation system 100. According to one embodiment, the process 200 is carried out by the computing system 102, and specifically the facilitation engine 128. For the exemplary process, it is assumed that a user, such as user 106 associated with address-A 136 (see FIG. 1), relocates from address-A to address-B 138. Although, as will be understood and appreciated, no relocation is required in order to utilize aspects of the facilitation system or computing system 102. At address-A 136, the user 106 has a satellite television connection 140, and a telephone connection 142, which the user wishes to disconnect or transfer to his or her new address. As shown at the new address (address-B 138), the user wishes to transfer the satellite 150 and telephone 144 services (potentially to new service providers with new service plans), and install new services such as an Internet connection 146 and electricity 148. As described previously, a user may or may not know which products or services he or she wishes to install at his or her new residence, and thus the order facilitation and recommendation process 200 carried out by the facilitation module 128 assists the user in selecting and ordering such products and services.

To this end, and referring to FIG. 2, at step 202, the user 106 accesses the computing system 102 via the network 112 and the user interface 126, and provides identification details to gain access to the computing system 102. FIG. 3 illustrates an exemplary “log-in” or user identification screen 300, which requests user information. The user interface 126 (e.g., screen 300 in FIG. 3) may have drop down menus, service buttons, or may require the user 106 to type in a query or response. Upon authorization, the user 106 is prompted for location information for the address at which a product or service is requested (step 204) (see FIG. 4 for exemplary location identification screen 400). In some cases, if the user 106 is a regular customer of the facilitation system 100, the user's information may be up-to-date in the databases, and the user 106 may not be required to enter any information into the address screen (step 206). Alternatively, the user interface 126 may display the user's last saved address along with other details and prompt the user to verify these details.

After the computing system 102 has identified the particular user and user's address, at step 208, the facilitation module 128 retrieves data from one or more databases 114 to determine products and services available to the user. In some cases, the retrieved information may be filtered before any analysis. For example, if the user 106 requires information about Internet, phone service, electricity, and cable services, information pertaining to service providers 104 that do not provide these services may be discarded. The retrieved product and service information may be further filtered by the user's address. If any service is not available at the user's address (for example, based on serviceability information or product and service requirements), information pertaining to that service can also be discarded. Additional details relating to filtering products or services based on serviceability information are provided below. It will be understood that various other filters may be applied to the data based on user inputs, or preferences, without departing from the scope of the present disclosure.

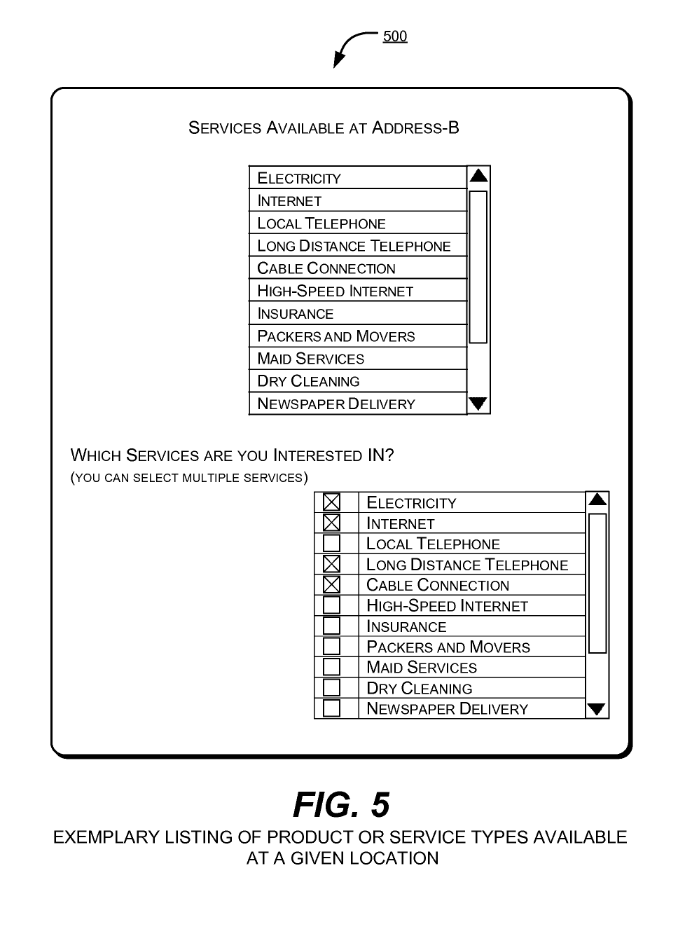

To install new products or services, the user 106 may want to know all of the products and services available at the new address (e.g., address-B 138), and the most appropriate services from the available list. At step 210, the facilitation engine 128 generates a list of available product and service types available at address-B 138 based on the information retrieved during step 208. As mentioned previously and as will be understood, according to one aspect, the list of service types or particular services may be presented based on previously-determined serviceability criteria. FIG. 5 illustrates an exemplary screen shot listing product and service types available at a given address. As shown, the user is able to select types of products or services in which the user is interested (step 212).

After a user selects one or more service types, the system 102 identifies and provides a list of the particular product and service plans associated with the selected service types. According to one embodiment, the facilitation module 128 provides specific recommendations of products or services to the user. To do so, the facilitation module 128 analyzes retrieved information along with the user's preferences to provide analyzed results to the user 106 via the user interface 126 (step 214). Specifically, based on the user's preferences and address—B 138 capabilities, the facilitation module 128 recommends products or services 158 to the user 106. These recommended products or services are intended to meet a desired objective (e.g., best suited for user's needs, most profitable services, etc.). The results may include a ranked list 160 of service providers, or a ranked list of product and service plans based on user preferences and ranking factors and/or serviceability information, a comparison report 164 of different providers or products and other similar results.

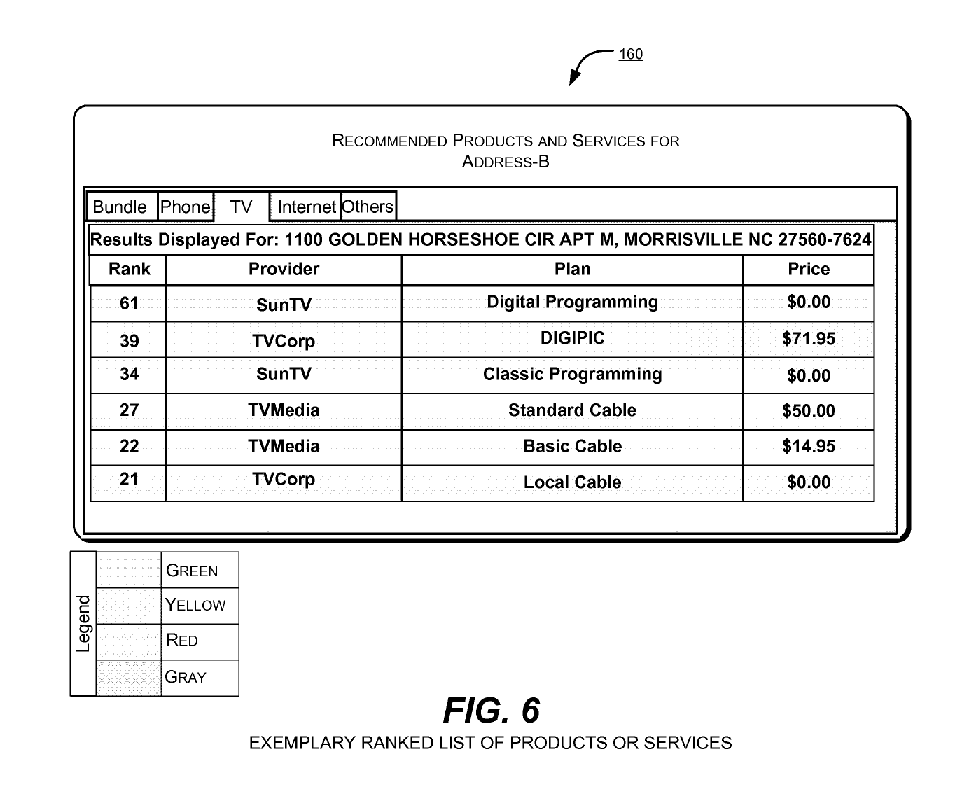

FIG. 6 illustrates an exemplary ranked list 158, 160 of products and services. Here, for each service type offered to a user, the facilitation module 128 provides an ordered list of the services. Based on these recommendations, the user 106 can make an educated decision regarding which service he or she wishes to purchase. Moreover, the user 106 does not have to visit multiple service providers 104, provide personal details to each vendor separately, or compare prices manually as the electronic system 100 aids the user 106 in all decisions pertaining to utility services or products. As shown, the listed products or services may be highlighted or indicated in a certain manner to show products or services that are more highly recommended based on a variety of factors. For example, services shown in “green” may be extremely well-suited for the given user's needs, whereas “yellow” services may be only partially recommended, and “red” services may be not recommended. “Gray” services, for example, may indicate that there is not enough information available to provide any recommendation regarding the service. As will be understood and appreciated, various ranking mechanisms and indicators may be used according to various embodiments of the present system.

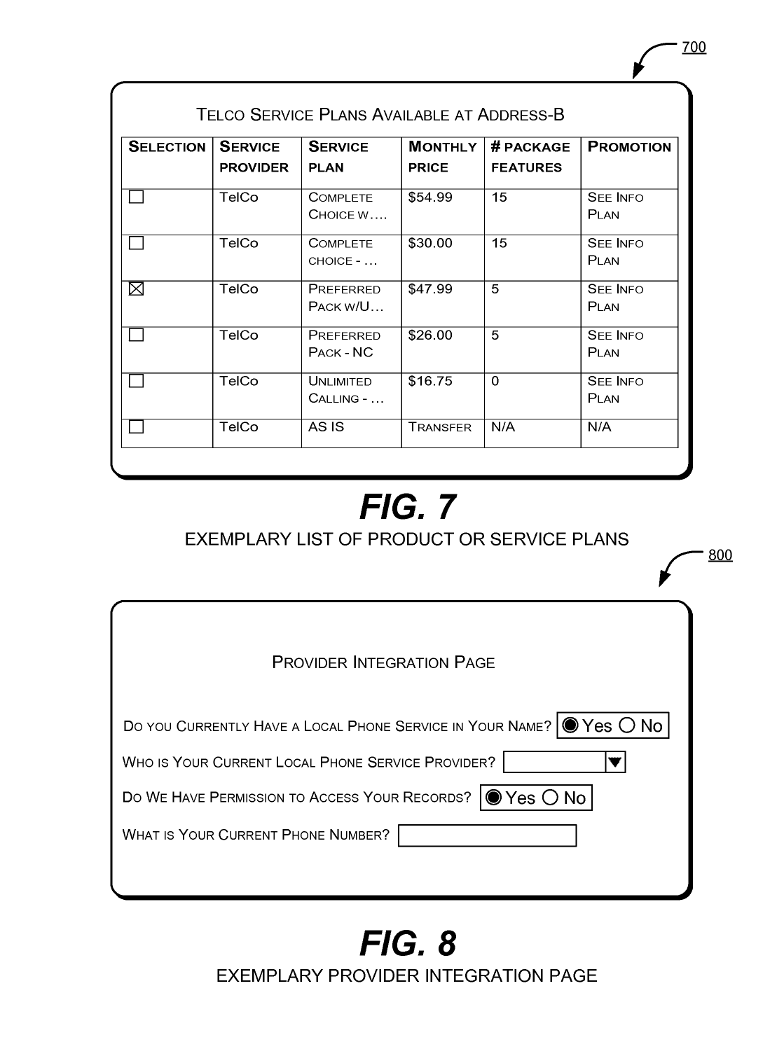

According to an alternative embodiment, rather than providing a ranked list of suggested products or services, the facilitation module 128 simply presents all products or services (e.g., of a given type, or offered by a particular provider) to the user. For example, as shown in FIG. 7, all services potentially available at address-B 138 offered by Telco are shown. In this way, the user can select from all products or services offered at a given location, whether those services are ranked or not.

In one embodiment, if the user 106 selects any service or product from either the ranked list or unranked list, such as a telephone service, the computing system 102 may interact directly with the service provider 104 that offers that service, in real time, to complete an order for the selected product or service, or a transfer of the product or service. In so doing, the system accesses particular user information, plan information, or service information. FIG. 8 illustrates an exemplary user interface 800 pop-up screen requesting details from the user. Here, the user may be asked questions relating to current phone services used for purposes of cancellation or transfer. Further, the computing system 102 may request the user's permission to access his or her records from his or her current phone service provider 104.

Additionally, if the user 106 selects a particular product or service plan from the list of available plans (e.g., from the Telco plans shown in FIG. 7, or the ranked cable service plans shown in FIG. 6), then the computing system 102 may update user or service information via the service provider's web portal. For example, if the user 106 wishes to modify a local telephone plan with Telco, the computing system 102 may directly connect to the Telco website, login, change the user's service plan, make payments, and update the user's connection plan. Further, if the user requests an additional phone line, the system can request installation services with the Telco website. In this manner, the computing system is able to efficiently interact with all the service providers 104, request installations, disconnections, or upgrades, in real time, in effect reducing or eliminating user interaction with individual service providers 104.

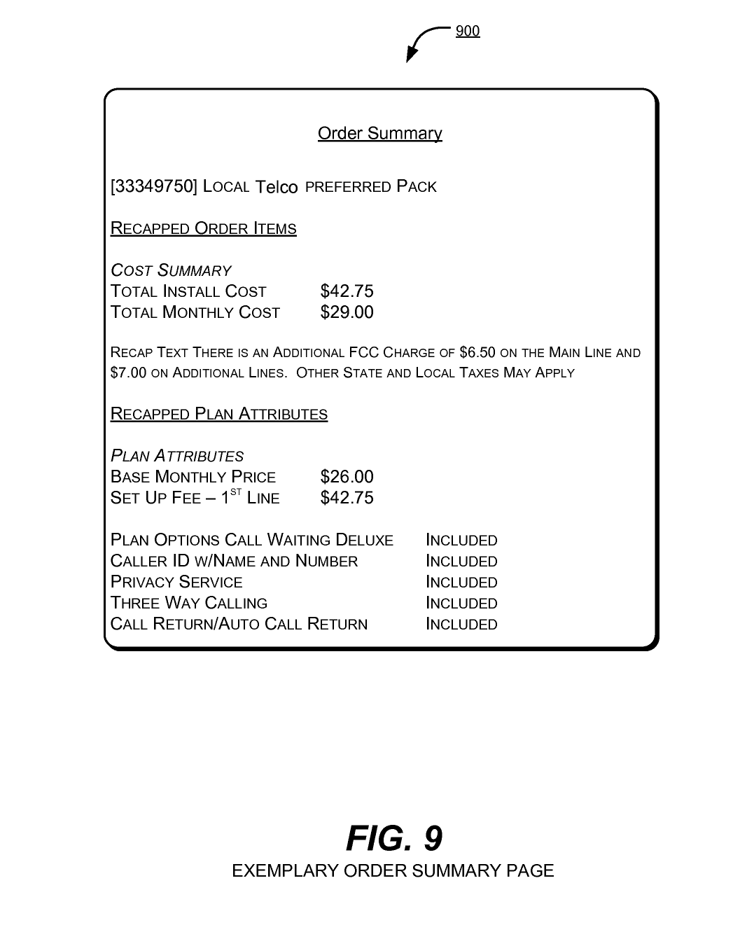

Alternatively, upon ordering a given service, the computing system 102 may receive the user's selection of a plan and store this information. Later, the computing system 102 may retrieve this information and provide an update to the associated service provider 104 with the user's selection. This update may be carried out through the Internet, via a phone call to a representative of the service provider 104, via a third party agent, or through any other communication method. Once the user's order is confirmed, the user interface 126 may provide a summary of the products or services ordered. FIG. 9 illustrates an exemplary order summary 900 indicating the user's acquisition of a new product or service. This information is stored in the customer information database 116 and the order history database 124 for future recommendations to the same or other users.

Having described the general functionality of an embodiment of the computer system 102, facilitation engine 128, database(s) 114, and other related components, a detailed description of an embodiment of the serviceability engine 132 is provided below.

### Exemplary Advisor Engine

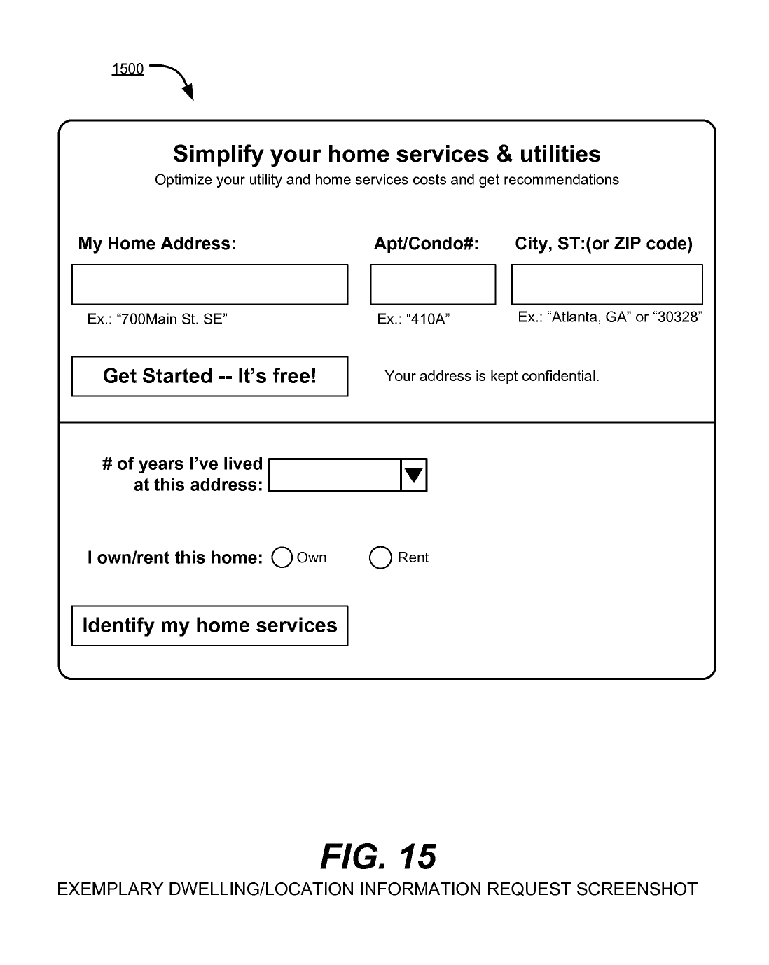

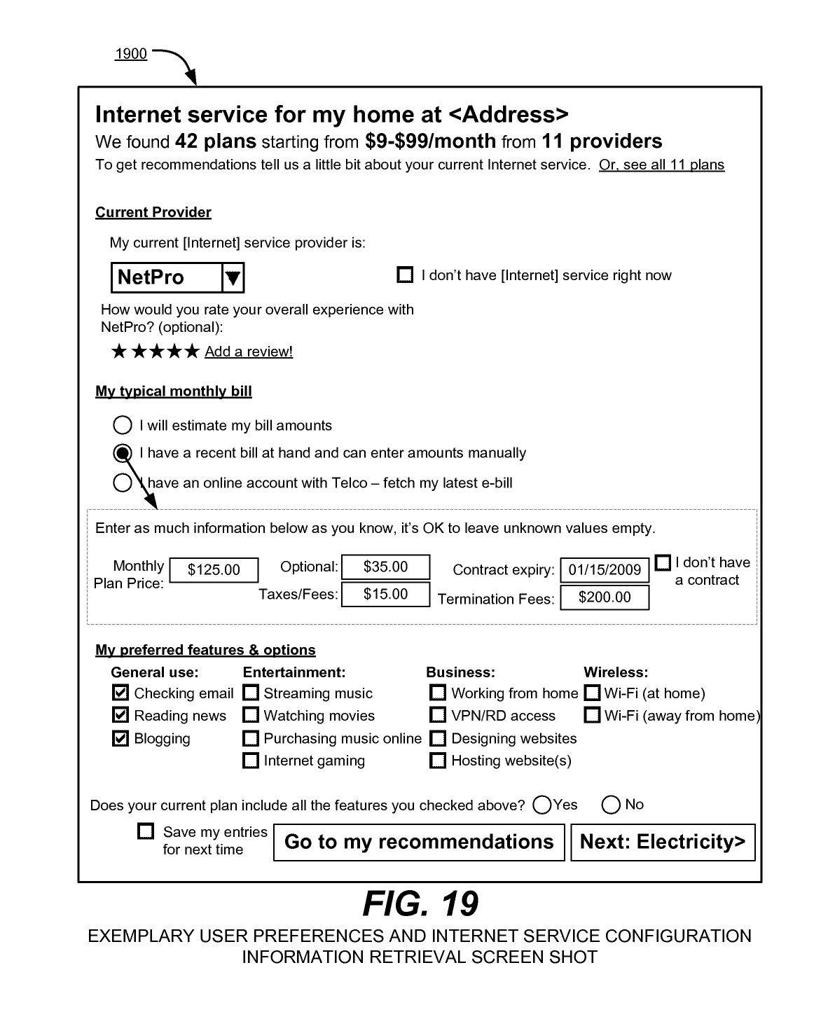

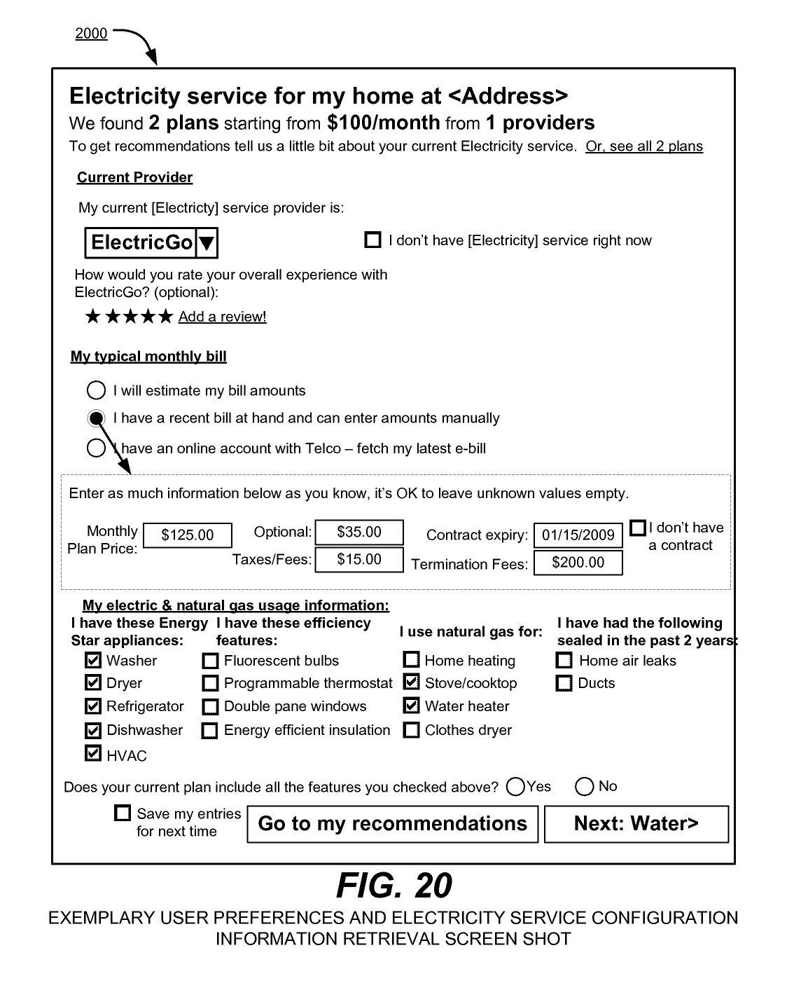

As described previously, one embodiment of the order facilitation system 100 includes a services management system and/or portal (e.g., advisor engine) 134 that enables each user to manage all or many of his or her third party products and services from one electronic platform. This management functionality may be subsequent to a user's order or transfer of products or services through the facilitation system, or may be utilized regardless of whether products or services have been ordered through the system (i.e., users can register their preexisting products or services with the services management system). As will be understood and appreciated, the services management system 134 can be accessed via a network 112 (see, e.g., FIGS. 15-26 for exemplary services management system portal screen shots), on a mobile device, via a call center, etc.

One embodiment of the advisor engine 134 includes operative connections to service provider systems so as to track customer usage of various third party products and services. This usage information is utilized to provide the user via the services management system 134 with a consolidated view of the user's products and services and enable the user to track usage and expense of the services, compare the expense to predetermined budget amounts, compare the usage to other users locally and nationally, etc. Additionally, the services management system provides alerts to the users (e.g., via email, mobile phone, text (SMS) message, etc.) when certain usage or expenditure thresholds are reached (e.g., mobile phone minutes overage, pay-per-view movie orders, etc.), when payments become due, or when new offers, deals, or service promotions become available, etc. Further, the system allows for consolidated bill payment from one convenient location.

Generally, the advisor engine 134 comprises an enterprise-wide framework for allowing users to manage and optimize third party products and services available at the user's geographic location based on information related to user preferences, product and service characteristics and capabilities, user demographics, dwelling or location characteristics, financial implications, product and service use, and similar parameters. In a basic illustrative example of the advisor engine 134 functionality and the user benefits associated with use of same, if a user 106 desires television service including basic cable channels and sports channels, and the user has a monthly budget of $125, and the user resides in New York, the advisor engine 134 can analyze data retrieved from the databases 114 and input by the user to recommend the best television services within the user's budget that meet the user's preferences. If the user does not wish to purchase or transfer his or her television service based on the recommendations, the advisor engine 134 provides future alerts to the user whenever a better service plan, service provider, or product is available in the user's geographic area that meets the user's requirements. Moreover, the advisor engine 134 can assist the user in optimizing his or her current television service by providing tips to reduce costs of the service, informing the user whenever monthly budgets for television usage have been eclipsed, providing in-depth information about average cable costs and usage in New York (and other locations), and so on.

As will be understood and appreciated, the products and services recommended to system users may be recommended based on a variety of factors and information, as described herein and as will occur to one of ordinary skill in the art. For example, a product or service may be recommended based on one or more parameters such as user preferences, popularity of each product or service, specific product or service details (e.g., price), offers or promotions associated with each product or service, the user's financial position and credit history, the user's previous product or service providers, previous user address, home capabilities, capabilities required for the service, and other pertinent parameters. In one embodiment, products and services that achieve a certain recommendation score may be highly suggested to users, whereas others may only be moderately suggested or not suggested at all. As will be understood, these product and service recommendations can be provided to users upfront when ordering or transferring new services, or intermittently via alerts or updates as consumers utilize current services when new or better service plan options become available or based on trends in consumer use, or upon specific request by a user, etc. By presenting intelligent recommendations and personalizing offerings to consumers, the advisor engine 134 can provide an optimal and personalized experience to consumers.

For example, based on user information, user preferences, and service usage information, the advisor engine 134 is able to classify users into different classes or profiles. The profiles may include information relating to a user's spending habits, credit score, typical product or service usage, typical service desires (e.g., typically requests high-end services or always requests only basic services, etc.). Recommendation of services or energy saving tips can be based on the customer profile, and specifically tailored to a user's needs (or, based on services most profitable to a service provider, etc.). Moreover, customer classification may be used for several marketing activities. For example, high worth customers may be provided special deals or promotions based on their service activity. Further details associated with providing user-specific service recommendations and/or information is described below.

Moreover, one embodiment of the advisor engine allows customers to “act” on suggested service recommendations by providing an automated way for users to purchase or transfer home services. For example, if a user receives an alert (e.g., via email) indicating that, based on the user's current Internet plan and typical monthly usage, a cheaper Internet service option is available from another service provider that still meets the user's needs, the user can select a “purchase” or “transfer now” button within an electronic interface screen that effectuates an automatic purchase or transfer of the selected service. To accomplish a transfer, for example, the advisor engine utilizes pre-stored user information and its operative connections to service providers 104 to disconnect the user's current Internet service, and subsequently register the user for the new Internet service.

In this manner, the advisor engine 134 provides users with a comprehensive solution for identifying home services best suited to them, and for signing up for the services quickly and efficiently online, or from a mobile device, or via a call center, etc. By making highly-personalized recommendations, taking into consideration several factors such as user preferences, demographic data, past service usage trends, service provider information, user credit information and so on, the advisor engine ensures that users are presented with the most cost effective services that fit their needs. Further, by storing the user's responses to previously-presented recommendations (whether or not the user actually purchased the recommendations), the advisor engine 134 is able to provide “fresh” or new recommendations every time the user employs the system. For example, if a given user has previously rejected, on multiple occasions, offers for “bundles” of services (i.e., grouping services together from a given service provider as a discrete unit), then the engine 134 may determine that the user is uninterested in service bundles, and learns not to offer such bundles in the future. As a result, the advisor engine 134 maintains long term customer relationships and enriches user experience by permitting users to configure their accounts to receive timely updates on usage trends, setup alerts for newly available money saving deals, alerts when usage thresholds are crossed, and so on. These and other advisor engine 134 features will be described in detail in the following sections.

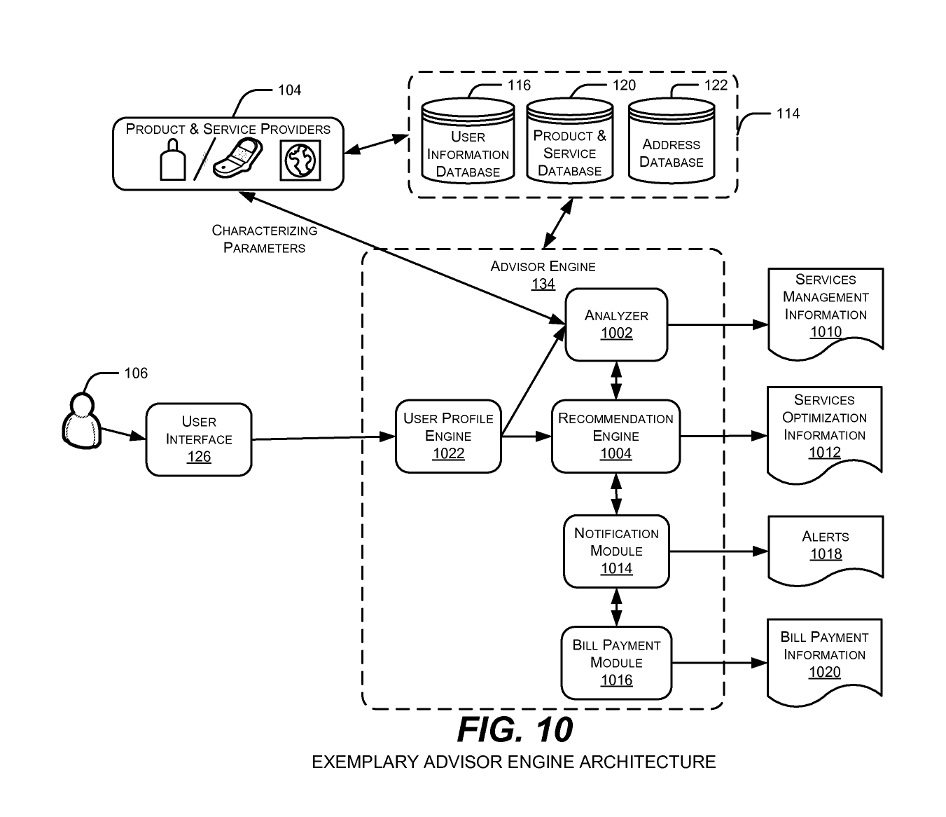

FIG. 10 illustrates an exemplary advisor engine 134 according to one embodiment of the present system. In the embodiment shown, the advisor engine includes an analyzer 1002 and an intelligent recommendation engine 1004. As will be understood and appreciated, embodiments of the analyzer 1002 and recommendation engine 1004 comprise algorithms, software modules, processors, or other system components to perform their associated functionalities. Generally, inputs to the analyzer 1002 include customer information from the user information database 116, address information from the address database 122, and service information from the product or service database 120. As will be understood, however, the advisor engine 134 may utilize other information sources as well, such as information from the order history database 124 or capabilities database 118, or from product and service providers 104 or other information sources 108, 110 in real time. As mentioned previously, the databases are generally populated with data provided by multiple external sources. For example, the system may obtain information to populate the various databases directly from the user 106, from third party product and service providers 104 via an operative connection between the system and the providers, or from external financial sources, geographical data sources, census data sources, and so on.

According to one embodiment, the advisor engine 134 also includes a notification module 1014, a bill payment module 1016, a user profile engine 1022, and other modules, components, and systems as will occur to one of ordinary skill in the art. Additionally, although not specifically shown, it will be understood that users 106, product and service providers 104, and other external entities communicate with the advisor engine 134 (and other computing system 102 components) via a network 112, such as the Internet. Further, according to one embodiment, the outputs of the advisor engine 134 include service management information 1010 relating to management of a user's products and services, service optimization information 1012 corresponding to recommendations or optimization of a user's products and services, alerts 1018 advising users of various product and service details, occurrences, or new plans, and bill payment information 1020 including bill due date notifications, requests for payment, etc. As will be understood and appreciated, the advisor engine 134 architecture shown in FIG. 10 is but one embodiment of the advisor engine 134, and is not intended to limit particular databases, engines, modules, outputs, and other components used in other embodiments of the system.

According to one embodiment, the analyzer 1002 applies various configurable and/or predetermined weights and calculations to the information received from the databases or other external sources to generate services management information 1010. This management information may include graphs, charts, text, etc. illustrating the user's service usage, expenditures, monthly costs, budget adherence, or typical service costs or usage in the user's neighborhood (or nationally, etc.). Using this information, users 106 can plan budgets or track “expenditure vs. budget” for all home services. Moreover, the services management information 1010 allows users to compare their service costs with users in their locality to determine average service costs. For example, if a user's electricity bill constantly exceeds the average electricity bill amount in his or her locality, the user may determine that he or she is not utilizing the electricity service in an optimal manner, or maybe another service plan may suit the user's needs better.

According to one embodiment, the recommendation engine 1004 provides services optimization information 1012 to a user 106 such as tips and tricks for optimizing usage of the user's home services, energy savings recommendations, or personalized product and service offers/recommendations based on the user's service usage patterns and service preferences. For example, if the user's electricity bill far exceeds the average bill value in the user's locality, the recommendation engine 1004 may recommend a service plan that is less expensive than the user's current plan, or the recommendation engine 1004 may recommend numerous energy saving tips, such as installing additional or new house insulation, environmentally-friendly rated appliances, and so on to reduce electricity usage. To arrive at these recommendations, the recommendation engine 1004 utilizes one or more proprietary algorithms that take into account parameters such as user preferences, current and past electricity usage patterns, electricity services available in the user's locality, house dimensions, dwelling type, number of occupants, and other such user, house, or service related information.

Further, the advisor engine 134 enables a user to purchase or transfer new or existing products or services based upon the services optimization information 1012. For example, if the optimization information 1012 includes a recommendation for a new service plan, the user 106 can select the recommended service plan, and the computer system 102 automatically changes the user's service plan (as described previously), by disconnecting the user's current service and connecting the user's selected service with the third party providers involved in the plan change, and then updating the plan change information in the customer information database 116. As an additional example, if the optimization information 1012 includes a recommendation for house insulation as a tip to reduce electricity bills, the computer system 102 can directly connect the user 106 to home insulation providers (e.g., providers that have partnered with the facilitation service 100), schedule an appointment, or provide approximate installation charges based on the residence information updated in the customer information database 116. As a further example, in some circumstances, the services optimization information will simply help the user save money, without the need for purchasing or transferring services (e.g., advising a user that he or she can save a certain amount per year if he or she sets his or her home thermostat to 68° F.). In this manner, the advisor engine 134 provides end-to-end management solutions to users by conducting a root-cause analysis, providing services management information 1010 and optimization information 1012, suggesting ways to optimize service utilization, and enabling users to act on these suggestions.

In another embodiment, if the user 106 is planning to relocate, the advisor engine 134 can automatically recommend optimal services to the user at the user's new address, based on stored customer information, service usage patterns, configuration information at the new address, user preferences, and services available at the new address. Users can accept the automatically populated service recommendations, which will initiate an automatic service cancellation (at the current address) and connection (at the new address) process on the relocation date, thereby providing seamless service to the user 106 and enabling him or her to relocate without worrying about contacting each service provider 104 individually to install services at the new address once the user 106 has relocated.

Further, in one embodiment, the advisor engine 134 includes a user profile engine 1022 for classifying users into one or more predefined categories based on external and internal parameters such as demographic data, services utilized, credit scores, and other similar parameters. Depending on the particular embodiment, the user profile engine 1022 can be configured to profile users into address-based categories, financial status-based categories, based on their service usage history, etc. Other categorizations are also contemplated and are not be outside the scope of the present disclosure.

Still referring to FIG. 10, the user classification determined by the user profile engine 1022 can be used to identify the most appropriate products, services, or energy saving tips for a given user. For example, if a user is in an “affluent” class (based on the user's credit score, usage history, etc.), then it may be determined that the user 106 may be more interested in higher-end or more expensive products or services. Thus, lower-end products or services may not be presented to the user (or may be presented further down a ranked list as “not recommended,” etc.). In addition to a general classification, a personalized user profile may be generated for each individual user (either independent of or as a sub-classification to the general classification) based on the specific user's preferences, service usage, demographics, etc. This personalized user profile can be used to generate or identify high-specialized services information 1010 or optimization information 1012.

As will be understood, user profiles can be generated and utilized in a variety of manners and according to a variety of factors. For example, a user profile for a given user may simply include a broad designation that a user is in an “affluent” class (e.g., based on the user's previous service purchases of high-end services, or if the user's yearly income is above a predefined threshold, etc.). If so, the advisor engine 134 may provide high-end service recommendations to the user for each service type. Alternatively, a given user may have different profiles for each type of home service utilized based on user preferences and service configuration information for each service type taken individually. For example, the advisor engine 134 may determine that a given user is willing to pay additional fees for entertainment-related services (e.g., television, Internet), but only desires basic or minimum service plans for all other services. In this case, rather than simply providing high-end service offerings to the user across all service types, the system can tailor specific offerings to the user (e.g., offer high-end television and Internet services, but basic electricity and telephone services). It will be understood, therefore, that a combination of general and individualized profiles may be utilized without departing from the scope of the present inventions.

As will be further understood and appreciated, user profiles may be generated via proprietary algorithms based on a variety of predetermined factors. For example, one factor may dictate that if a given user typically uses more than 20% more electricity than an average user (with similar home requirements, members living in the home, etc.), then the user is sorted into a “high use” class for electricity service. This profile could be used to suggest ways to the user to lower his or her monthly electricity usage. As another example, a factor may dictate that if a given user purchases “upgrades” on more than two offered services, then the user is sorted into a class indicating the user desires or is willing to spend additional funds on service upgrades. In this way, a user's profile (or profiles) can be used as a filter to sort out services the user may or may not be interested in, or could be used as the sole factor for determining which services to offer to a given user. As will be understood, and as mentioned previously, each user profile may include a host of sub-profiles or categories that are determined in a variety of ways to accurately and specifically determine which products or services a user is likely or willing to purchase.

In addition to presenting the most optimal or appropriate service recommendations to a user, the user profile engine 1022 output can also be employed to handle other situations such as managing call overflow in customer support centers (e.g., call center) for the electronic system 100. For example, in an overflow situation in which the facilitation service 100 experiences a high volume of customer calls, high value customers can be directed to a qualified or experienced agent, medium value customers to an interactive voice response (IVR) service (which can qualify their interest in certain products or services), and low value customers can be placed on hold. User segmentation and filtering can also be performed based on the output of the user profile engine 1022, where calls from a particular location (e.g., zip code) are forwarded to product specialists depending on product availability. For example, a call from a non-cable zip code can be forwarded to a satellite TV agent. Another advantage of profiling users is to match users to specific agent types to gain maximum yield. For example, high profile customers can be directed to high-performing agents, medium profile customers to average-performing agents, and low profile customers to low-performing recruits.

In addition to the analyzer 1002, the recommendation engine 1004, and the user profile engine 1022, one embodiment of the advisor engine 134 includes a notification module 1014 and a bill payment module 1016. Users can set multiple alerts 1018 using the notification module 1014, enabling the advisor engine 134 to alert the user 106 whenever thresholds corresponding to the alerts 1018 are exceeded. Because product and service information is constantly changing (e.g., service providers continually offer new or different promotions or plans), users may be interested in being notified when certain promotions or plan specifics become available. For example, a user 106 may be interested in receiving alerts relating to telephone plans that can save the user more than $10/month (but may not want to be bothered with plans that will save the user less than $10/month over his or her current service). In that case, the user 106 can configure a notification that alerts the user 106 only when the system uncovers a telephone service suitable to the user that helps the user 106 save more than $10/month.

Alternatively, a user 106 can configure usage related notifications. For example, a user may configure the notification module 1014 to alert the user whenever the user's mobile phone usage exceeds the user's predetermined minutes plan (and thus when the user begins using “overage” minutes). The notification module 1014, then, monitors the user's cell phone usage in real time (via a direct connection to the user's mobile phone service provider's system), and sends the user an alert 1018 whenever this threshold is surpassed. In this manner, users can configure numerous alerts 1018 that can help manage home services more proactively, or provide highly personalized recommendations. Moreover, the notification module 1014 can use any mode to alert users, such as the Internet, email, telephone, SMS, or other similar notification mechanisms.

According to one embodiment, the bill payment module 1016 allows users to pay their service bills (and set up automatic payment options) using the advisor engine 134. The bill payment module 1016 interfaces directly with service provider billing systems to retrieve issued bills and billing information from third party service providers 104, and provide that bill payment information 1020 to system users 106. Payments can be made through various conventional mechanisms, such as credit cards, debit cards, through online transactions, using bill pay clearinghouses, and so on. Alternatively, users may provide standing instructions to the advisor engine 134, enabling the bill payment module 1016 to pay bills automatically on or before due dates. For example, a user may instruct the bill payment module 1016 to pay all outstanding bills from her savings account on the 10^{th} day of every month. To this end, the bill payment module 1016 may request bank detail information from users and store this information in the user information database 116. Alternatively, for security purposes, user account information may be encrypted using suitable encryption standards and stored in a separate secure database. Further, the bill payment module 1016 may be operatively connected to the notification module 1014, so that alerts 1018 relating to bill payment due dates can be sent to users of the advisor engine 134.

### Exemplary Database(s)

The following sections describe exemplary databases utilized for efficient functioning of the advisor engine 132. It will be understood, however, that the specific databases, database schemas, tables, and specific information shown are provided for illustrative purposes only, and are not intended to limit the scope of the present disclosure. Other information items, formats, databases, etc. are contemplated within embodiments of the present system as will occur to one of ordinary skill in the art.

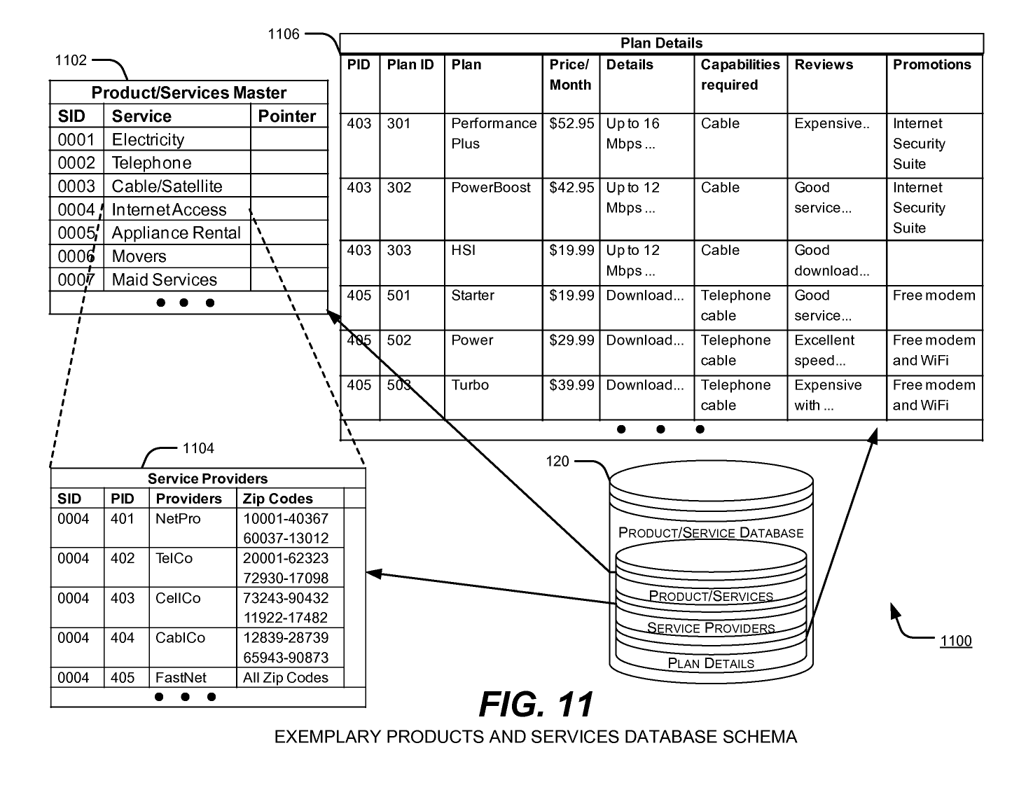

FIG. 11 illustrates an exemplary products and services database schema 1100 according to one embodiment of the products and services database 120. As described previously, the products and services database 120 includes information pertaining to products and services offered by third party service providers 104, capabilities at an address required to effectuate those services, costs of the products and services, etc. Generally, this information is retrieved in real time or at predetermined intervals from various third party service providers 104 or other external sources 110. For example, information such as demographic areas serviced, products offered, price plans, promotions, types of services offered, sales, etc., are obtained at regular intervals from the service providers 104, while information such as product popularity, reviews, ranking may be retrieved regularly from the customer information database 116, external sources, from the consumer engine 132, or the output of the recommendation engine 1004. To this end, the computing system 102 includes operative connections to third party service provider systems to facilitate information exchange between the systems. In an alternate embodiment, a representative of the facilitation service 100 manually contacts each service provider 104 at regular intervals to obtain updated product or service information.

Once product or service information is retrieved from various product or service providers 104, specific characterizing parameters associated with each product or service, such as plan name, plan price, geographic areas serviced, etc., is stored in the product and services database 120. Information pertinent to other characterizing parameters associated with each product or service (or plan), such as product popularity, product rank, reviews, etc. may be retrieved from external sources 110 or generated within the computing system 102. This information is stored systematically under each characterizing parameter in the services database 120. It will be understood that the characterizing parameters may have variable update requirements (for example, the “price” parameter may change more frequently than the “plan name” or “demographics served” parameters), and thus various characterizing parameters associated with a given product or service offering may update more or less frequently than others. In another embodiment, the information corresponding to all the characterizing parameters is refreshed regularly.

Still referring to FIG. 11, as described, the products and services database 120 provides input information into the analyzer 1002, the recommendation engine 1004, the notification module 1014, the bill payment module 1016, and the user profile engine 1022. According to one embodiment, the database 120 may store data in a relational fashion. A typical relational database includes a plurality of tables, each table containing a column or columns that other tables can link to in order to gather information from that table. By storing this information in another table, the database 120 can create a single small table with the locations that can then be used for a variety of purposes by other tables in the database. FIG. 11 illustrates some exemplary tables that may be present in the services database 120. It will be understood, however, that the number of tables, specific tables shown, data in the tables, and the relation between the tables may vary depending on the particular embodiment, without departing from the scope of the present disclosure.

As shown in FIG. 11, the schema 1100 includes a product or service master table 1102, which includes a list of product or service types offered by third parties and provided for purchase via the facilitation system 100. In the embodiment shown, each product or service type is associated with a unique service identification number (SID). The master table 1102 can be related to one or more other tables through the unique SID. For example, the master table 1102 may be related to a service provider table 1104 that stores data corresponding to available service providers 104 for a particular service and the geographical locations serviced by the service provider 104. In this example, the service provider table 1104 depicts Internet service providers associated with the electronic system 100, along with the zip codes serviced by each. Each service provider 104 is associated with a unique provider identification number (PID). The service provider table 1104 in turn may be related to other tables that include details about the service providers 104, such as addresses, contact details, geographical areas serviced, and the like. As will be understood and appreciated, other information for each service provider may be included depending on the particular embodiment.

Additionally, the service provider table 1104 may be related to a plan details table 1106. This table stores additional information related to the product or service plans offered by the service providers 104. Some exemplary data fields (e.g., characterizing parameters) may be plan name, price, plan details, capabilities required, plan popularity, plan reviews, promotions offered, and other similar fields. Other data fields (not shown) may include data rates offered, installation charges, and other pertinent data fields. As will be understood and appreciated, virtually any type of data or information relating to products and services offered by the electronic system 100 may be stored in the product and service database 120, and the product and service information utilized according to embodiments of the present system is not limited by the exemplary information shown and described in conjunction with FIG. 11.

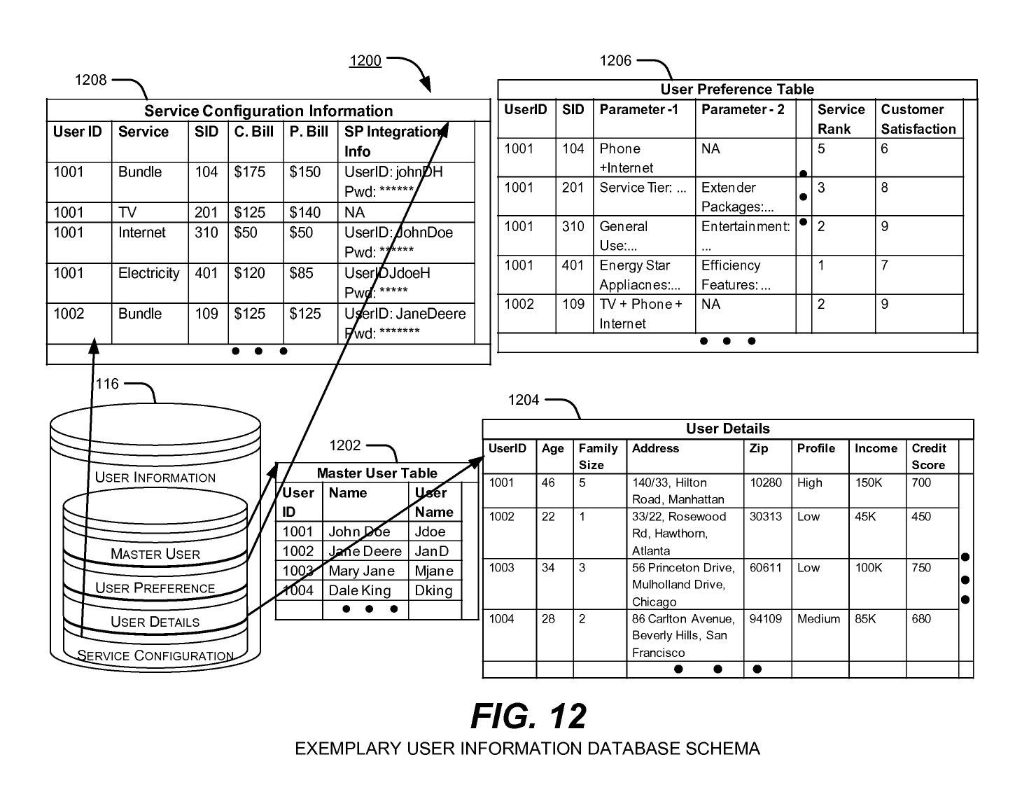

FIG. 12 illustrates an exemplary user or customer information database schema 1200 according to one embodiment of the user information database 116. As described previously, the information in the user information database 116 is generally used as an input into the analyzer 1002, the notification module 1014, the bill payment module 1016, the recommendation engine 1004, and/or the user profile engine 1022. Similarly to the database schema described in reference to FIG. 11, the user information database 116 may also comprise a relational database including several inter-related tables. In the embodiment shown, the schema 1200 includes a master user table 1202 including names of the users registered with the computing system 102, along with their usernames and unique user IDs. This table 1202 may be related or connected to one or more other tables, such as a user details table 1204, which includes user profile details including user age, family size, address, zip code, user profile rating, income, credit score, and other relevant details. Other data fields or tables may include information such as current services used, average service usage per billing cycle, past and present bill amounts, user preferences (e.g., prefers high-end services), payment details, credit card information, user passwords, and so on.

As shown in FIG. 12, the products and services database 120 may include a user preference table 1206, including information pertinent to each user's current products or services and/or service preferences. For example, the data fields in the user preferences table 1206 may include user ID, service type, various user parameters such as the user's typical service usage, derived preferences (e.g., user prefers high-end services), service rank (e.g., based on advisor engine calculations for which service may be most optimal for a given user), and customer satisfaction with the product or service (e.g., based on individual user review or average reviews, etc.). Another table, a service configuration information table 1208, includes further information pertinent to the user's current services. For example, the table 1208 may include user ID, service type, service provider, service ID, current bill, previous bill amounts, service provider integration information, and so on.

As will be understood and appreciated by those of ordinary skill in the art, information stored in the user information database 116 may be static or can be refreshed at regular intervals. For example, user details may be static information, while usage bills may be updated every month or every day (or even more frequently). Moreover, the information in customer information database 116 may be retrieved from users directly via the interface 126 or a call center, from third party service providers 104, or from external sources as previously mentioned. It will be understood that the tables in the user information database 116 may have more or fewer data fields, or completely different data fields, as compared to the exemplary tables depicted in FIG. 12. Further, the type, number, and size of the tables may also vary without departing from the scope of the present disclosure.

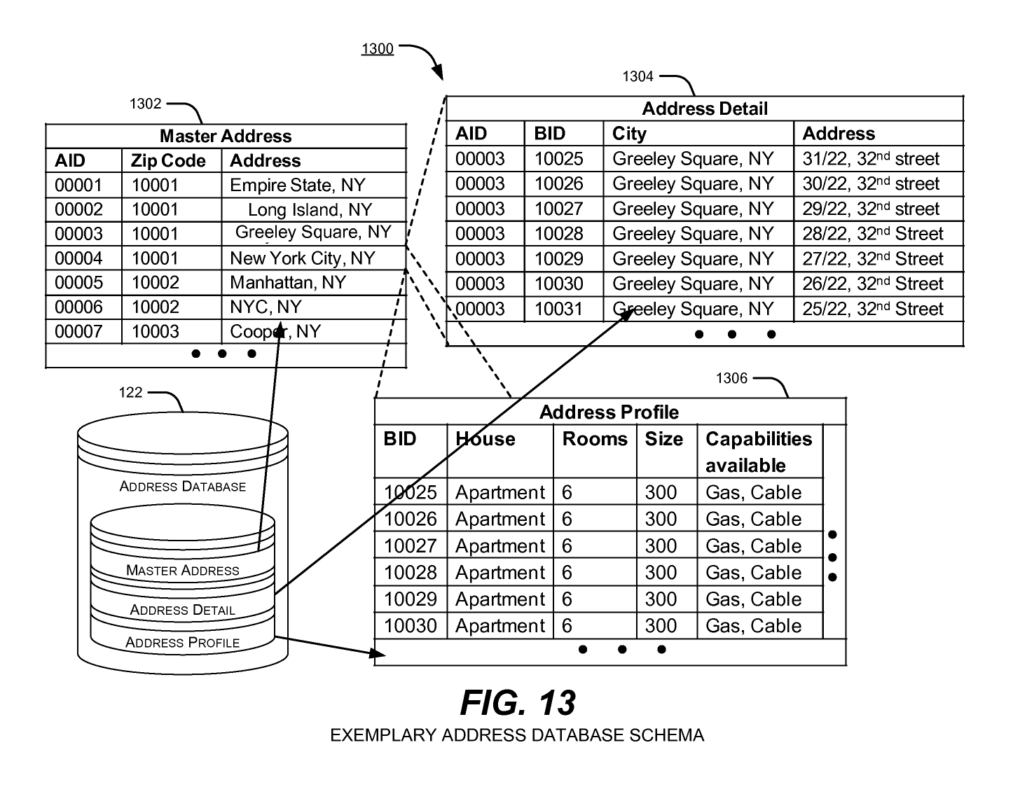

FIG. 13 is a database schema 1300 illustrating exemplary data tables in one embodiment of the address database 122. Similar to FIGS. 11 and 12, the tables in this exemplary database have pointers and relations, cross-referencing data from one table to another. According to the embodiment shown in FIG. 13, the schema 1300 includes a master address table 1302 including address information for particular geographic regions or areas. For example, the master address table 1302 may store city, state, county, etc., data for every zip code in the U.S. (or zip codes in a certain region, etc.). Each address or entry in the master table 1302 is associated with a unique address identifier (AID). The database may include separate tables for each AID, with actual residence or location addresses within each particular AID. For example, within AID 00003, there may be sub-identifiers for each apartment number, or specific address, or building, etc. This information is depicted in exemplary address detail table 1304.

Further, each entry in the address detail table 1304 may be linked to an address profile table, such as the address profile table 1306. This table 1306 may include specific details about each residence, such as residence type, number of rooms, plot size, capabilities available at the residence, and other similar details. It will be understood that various other parameters may be included in the address profile table 1306, describing various other property details, such as previous services installed or provided at the address, service providers used previously or currently, and so on. Again, it should be understood that that the specific databases tables and specific information shown therein are provided for illustrative purposes only, and are not intended to limit the scope of the present disclosure.

Generally, the address data in the address database 122 may be provided from a variety of sources. For example, a user may input user address information into the present system, or information in the address database may be pre-populated from one or more external information sources 110 or external databases, such as the U.S. Postal

Service database, real estate databases, census information, third party providers, and so on. The address detail information is typically standardized and stored in a predefined and configurable format for purposes of comparison with product and service capabilities and other processing. Moreover, the address information may be refreshed regularly. For example, the capabilities available at the address may vary over time, with new service connections, hardware, or services being available at an address or certain other services discontinued at the address. The address database 122 should be regularly updated for efficient functioning of the advisor engine 134 and other system components.

It will be understood that various other parameters may be included in the address profile table 1306 and other tables in the address database 122, describing various other property details, such as previous services installed or provided at the address, service providers used previously or currently, and so on. It will also be understood that these tables are merely exemplary and may not represent the actual number or type of tables, or data values that may be present in the address database 122.

Additionally, although not specifically shown (but described previously), other databases, such as the order history database 124 and capabilities database 118 may be used according to various embodiments to supply necessary information for providing service recommendations to users. For example, based on previous service orders placed by a system user, the advisor engine 134 may determine that a new product offering does not meet the user's preferences, and thus should not be offered to the user. Further, products or services that require capabilities not present at a user's address (e.g., satellite dish required) may be filtered out before recommending service options to users. As will be understood and appreciated, various other information sources as will occur to one of ordinary skill in the art may be used according to various embodiments of the present system.

### Exemplary Method(s)

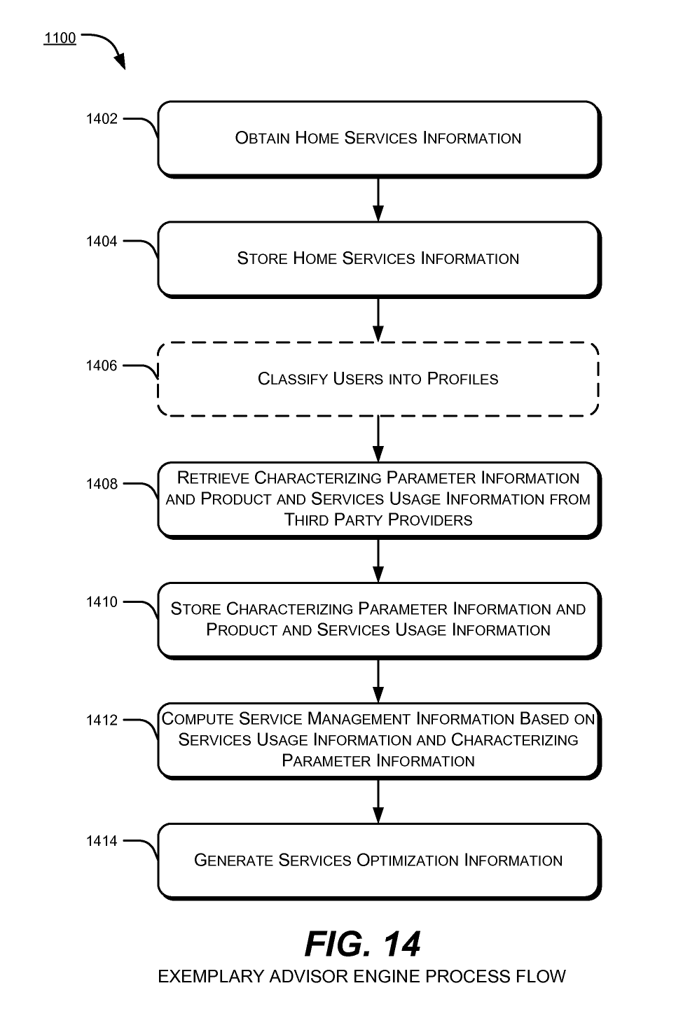

FIG. 14 is a flowchart illustrating an exemplary process 1400 for providing services management information 1010 and optimization information 1012 to users regarding their third party products and services according to one embodiment of the present advisor engine 134. Beginning at step 1402, the advisor engine 134 obtains product and services information for a given user. This information is retrieved either in real time from user 106 and various external sources or from the one or more internal databases 114. Initially, according to one embodiment, a user 106 is required to setup an account with the advisor engine 134. To this end, the user 106 may follow an account set-up procedure via the user interface 126. The process may include any processes known in the art such as entering a username and password, email addresses, basic identification information, and so on. Once a user account is created, upon returning, the user 106 is merely required to login to the system. FIG. 3 illustrates an exemplary user login screen shot for accessing the services management system/portal 134.

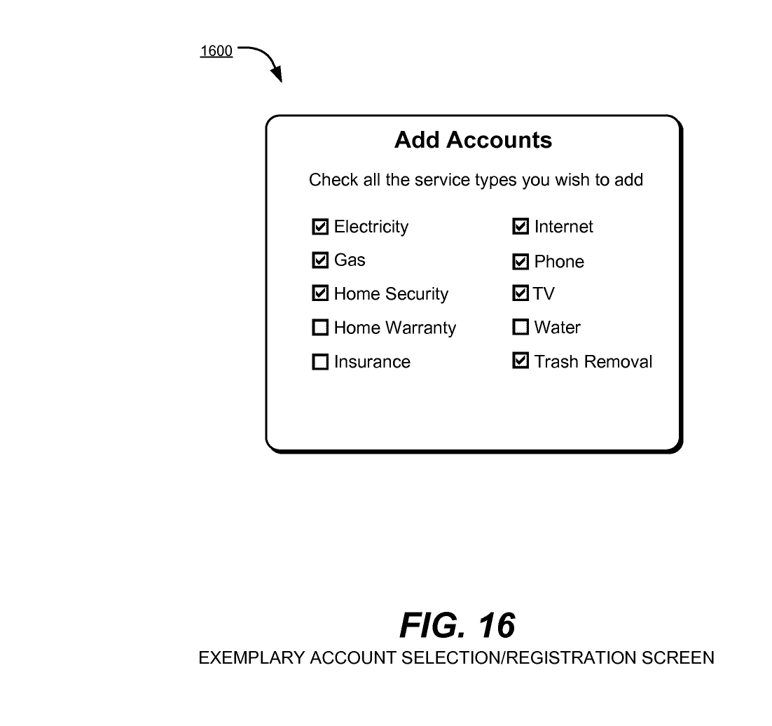

Upon setting up an account, the user 106 is generally probed for further home services information (either immediately or when the user logs-in to the system at a subsequent time). The home services information may include information such as dwelling address, dwelling type, home services currently utilized, home services required (or desired), etc. FIG. 15 illustrates an exemplary screen shot 1500 for obtaining dwelling information related to a user's address or geographic location. As shown, the user may enter the address of the location, how many years the user has lived there, whether the user owns the dwelling, etc. Further, FIG. 16 illustrates an exemplary screen shot 1600 for identifying which services the user wishes to purchase, or which existing services the user wishes to monitor and manage via the services management system 134. As will be understood and appreciated, the screen shots shown are provided for illustrative purposes only, and are not intended to limit the present disclosure.

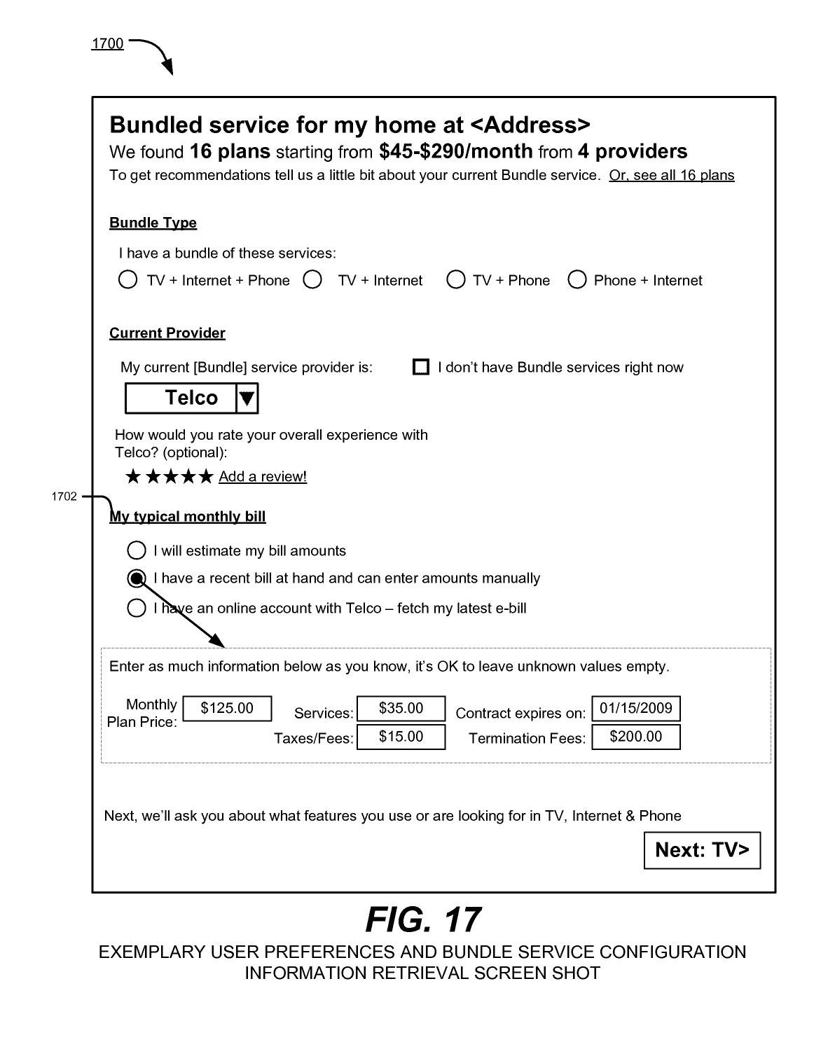

For each home service selected (e.g., via screen 1600), the advisor engine 134 obtains information relating to the user's current products or services (if applicable) (e.g., “configuration information”), and the user's preferences (e.g., “preference information”) for those services or new ones. In one embodiment, the user interface 126 may request the user to answer a short questionnaire for each selected service (as depicted in FIGS. 17-20), which may require textual input or selections from drop-down menus, scrolls, and other such information obtaining techniques. Alternatively, in a call center environment, a customer support representative may verbally ask the users questions pertinent to their home service preferences and current configurations. It will be understood that any other method for obtaining this information from the users 106 is contemplated and is within the scope of the present application. The answers entered by the user 106 are stored in the customer information database 116 under defined headers as illustrated in FIG. 12.

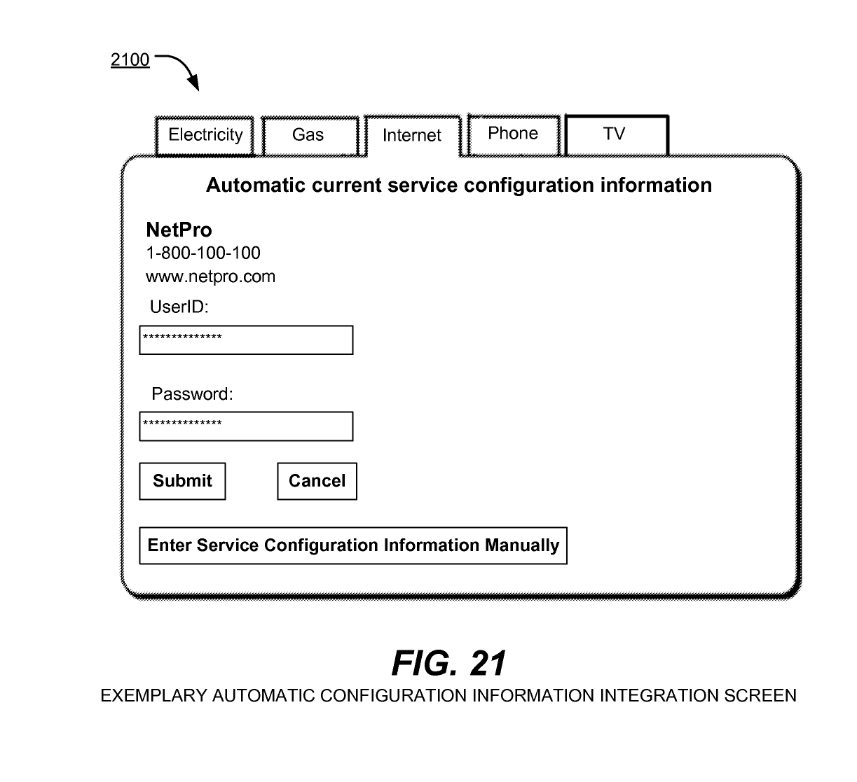

FIGS. 17-20 illustrate exemplary information retrieval screens for obtaining product and service information (e.g., configuration information and/or preference information) from system users according to one embodiment of the present system. For example, FIG. 17 illustrates a screen shot 1700 for obtaining information about a user's “bundled” services (e.g., television+Internet+phone service, all provided in one package). Regarding service configuration information, the system prompts the user to enter the type of bundle the user currently utilizes, the service provider that provides the bundle, how the user would rate the service, how much the user pays per billing cycle for the service, if there is a contract, etc. Alternatively, the user 106 may allow the advisor engine 134 to automatically retrieve service configuration information directly from the service providers 104. With this feature, the advisor engine 134 can retrieve updated user bills and service usage information upon selection by the user, and subsequently in real time or at predetermined time intervals, such as hourly, daily, weekly, monthly, quarterly, or annually, based on user approval or system requirements. FIG. 21 illustrates an exemplary automatic service configuration information integration screenshot 2100, in which a user provides his or her service provider log-in information to enable the facilitation service 100 to automatically retrieve service-specific information.

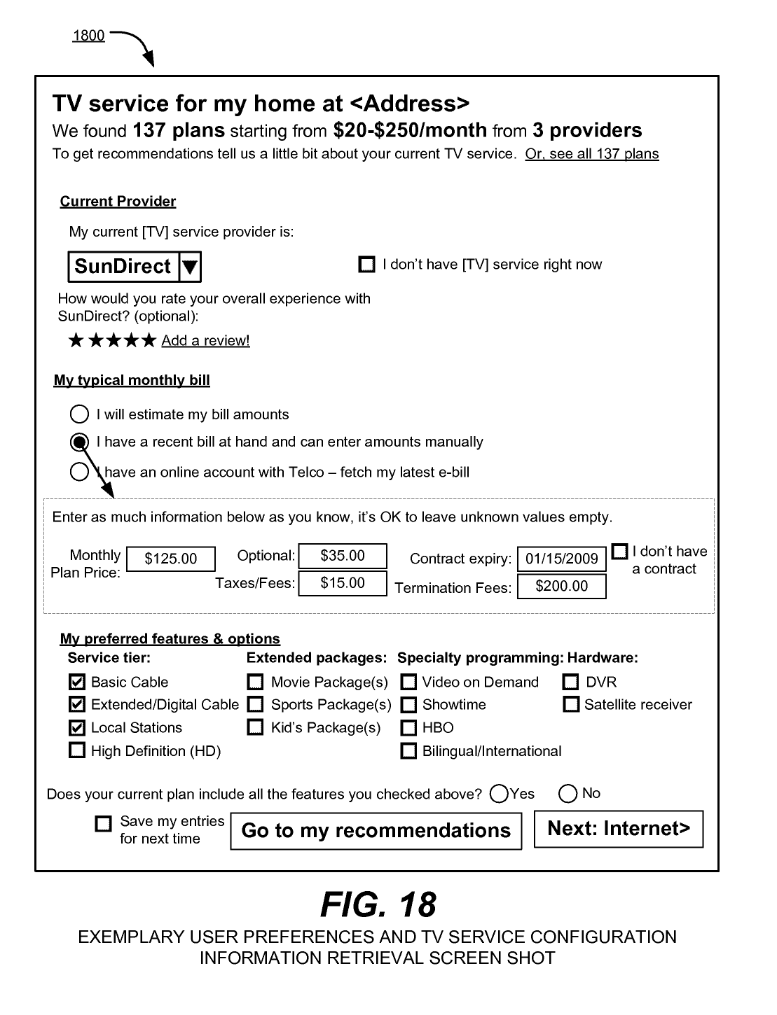

Regarding user preference information, the advisor engine 134 prompts the user for desired features the user 106 wishes to include in his or her new service plan, or current features associated with the user's current plan (that he or she likes or does not want to give up). For example, FIG. 18 illustrates an exemplary information retrieval screen 1800 for television service according to one embodiment of the present system. As shown, the screen 1800 includes a list of selectable options (preferences) for the user to select. In the embodiment shown, the user has selected “basic cable”, “extended/digital cable”, and “local stations” as his or preferred options. Further, the user 106 has not selected any of the additional features, such as “high definition”, “video on demand”, etc. Based on this information, the advisor engine 134 can filter out product or service plans (particularly more expensive plans) that the user will likely not be interested in. For example, FIG. 18 indicates that 137 television plans were identified with varying prices that are available to the user's address. However, given the preference information, the advisor engine may be able to eliminate many of the found plans (e.g., plans that include many additional features, such as high definition programming). In this way, when the user clicks on the “go to my recommendations” button within screen 1800, the engine 134 can present only those service plans that meet the user's preferences (see step 1414 described below).

Referring again to FIG. 14, at step 1404, the home services information (user preferences, service configuration information, dwelling information, etc.) is stored in the customer information database 116 (or other pertinent databases). It will be understood that the customer information database 116 (or any other system database) may include multiple physical databases, such as a customer account database, a service configuration information database, a customer preference database, and so on, without departing from the scope of the present application. Alternatively, the customer information database 116 may include one large database storing the home services information in a central location.

In one embodiment, based on one or more user detail parameters (i.e., the specific items of information stored or retrieved for each user), the user profile engine 1022 categorizes the users at step 1406. As will be understood and appreciated, step 1406 is optional, and embodiments of the present system may not always classify system users. Further, either in addition to or in lieu of a general classification, an individualized user profile (as described in detail above) may be utilized to specifically tailor service recommendations and/or service management information/advice to each particular user. Regarding general classifications, administrators may specify one or more classification schemes, based on the parameters, such as high priority customers, regular customers, and low priority customers, or service-based categorizations, or even address-based categorizations, and so on. Alternatively, customers may be ranked (e.g., on a scale of 1-10) according to a composite score of weighted parameters associated with each user, wherein the ranking corresponds to a certain criteria (e.g., high value customer, new customer, etc.).

For each classification scheme, a different set of parameters may be used. For example, to classify users as premier, gold, or silver customers, the user profile engine 1022 may use a user's service usage history, income details, and credit scores. Alternatively, to classify users 106 based on required services, the user preference information alone may be used. It will be understood that a number of classification systems may be contemplated, using one or more user detail parameters. Further, the user profile engine 1022 may apply different weights to the parameters; for example, while classifying users as premier, gold, and silver, the user profile engine 1022 may assign higher weights to the user's service usage history as compared to the user's income or age. Generally, the weights, parameters, and classification schemes used are predetermined by a system administrator. In one embodiment, however, these factors are identified dynamically based on pattern recognition within users.

The values corresponding to the parameters may be calculated to obtain a final score for the user 106. Each category in a classification system can include a range of scores, and this information may be stored in a look-up table. By tallying the user's score with the category ranges in the look-up table, the user profile engine 1022 assigns a category to the user 106. User classification in this manner may be used internally within the computer system 102 to manage call center queues, optimize user experience, and optimize call handing times. For example, high value customers can be addressed first.

Also, the user classifications can be used to recommend certain products or services over other products or services. For example, some of the products or services may be removed from the list or pool of recommended products/services (or moved in terms of priority within the list) based on a customer's classification (e.g., expensive products may be removed for customers in a “low value” class corresponding to low incomes). Further, the user profile information may be provided to the recommendation engine 1004 to provide the most relevant results to the user 106.

Next, the advisor engine 134 retrieves characterizing parameter information and service usage information from the third party product and service providers 104 for the given user (step 1408). As mentioned previously, characterizing parameters include details or features that make up or describe a product or service offering or offerings, such as the particular services offered, demographic areas serviced, service plans offered, service plan details, plan prices, offers, and so on. Other examples of characterizing parameters may include new services introduced, promotions, sales, product popularity, product ratings, user reviews, etc. Information is retrieved for these characterizing parameters from the third party service providers 104, external sources, the customer database, etc. This information may be retrieved in real time or at predetermined intervals of time. For example, service plan details may be refreshed every month, while product ratings may be refreshed every week.

Further, the advisor engine 134 retrieves service usage information corresponding to product and service usage of the given user. As mentioned previously, this information generally indicates a consumer's use of a given product or service in real-time, or in a given time period, or an average across several billing cycles, etc. According to one embodiment, a user's service usage information is retrieved form product and service provider systems (via operative connections between the computing system 102 and the service provider systems, e.g., via a network 112) in real-time to reflect the user's actual, current usage of that product or service (e.g., within a given billing cycle). For example, the service usage information may include the number of mobile phone minutes used by a given user that month, or the amount of electricity used, etc. In another embodiment, the service usage information for previous billing cycles is retrieved, either from product or service providers 104 directly (e.g., via access to their issued bills or billing systems) or from stored usage or billing information in one of the system databases 114. In this way, embodiments of the present system can provide current, real-time service usage information (e.g., to assist a user in determining whether he or she will soon eclipse a usage threshold), or past or average usage information for helpful comparisons, usage tracking and pattern recognition, etc.

Still referring to FIG. 14, at step 1410, the retrieved characterizing parameter and service usage information is stored in the system databases 114 for further use. Next, (at step 1412) the advisor engine 134 computes service management information 1010 based on the service usage information and the characterizing parameter information. In one embodiment, the analyzer 1002 collects service usage information (and characterizing parameter information, user information, address information, etc. as necessary) and performs calculations on this data to provide users with multiple forms of services management information 1010. The services management information is generally intended to be a useful guide for system users 106 to track their monthly expenditures and/or usage of their home services, compare their usage to others in their community (or nationally) who have similar products and services, identify when certain budgets or usage thresholds are crossed, identify ways to decrease service usage or maximize efficiency, and so on. For example, services management information 1010 may include bars graphs, charts, textual descriptions, pictures, and other statistical analyses indicative of periodic (e.g., monthly) or current service usage, service expenditure, country, state, or neighborhood-wise service expenditure or usage comparisons, usage in excess of preset monthly thresholds, etc. As will be understood and appreciated, virtually any statistical or predefined information can be provided corresponding to a user's home service usage as will occur to one of ordinary skill in the art.

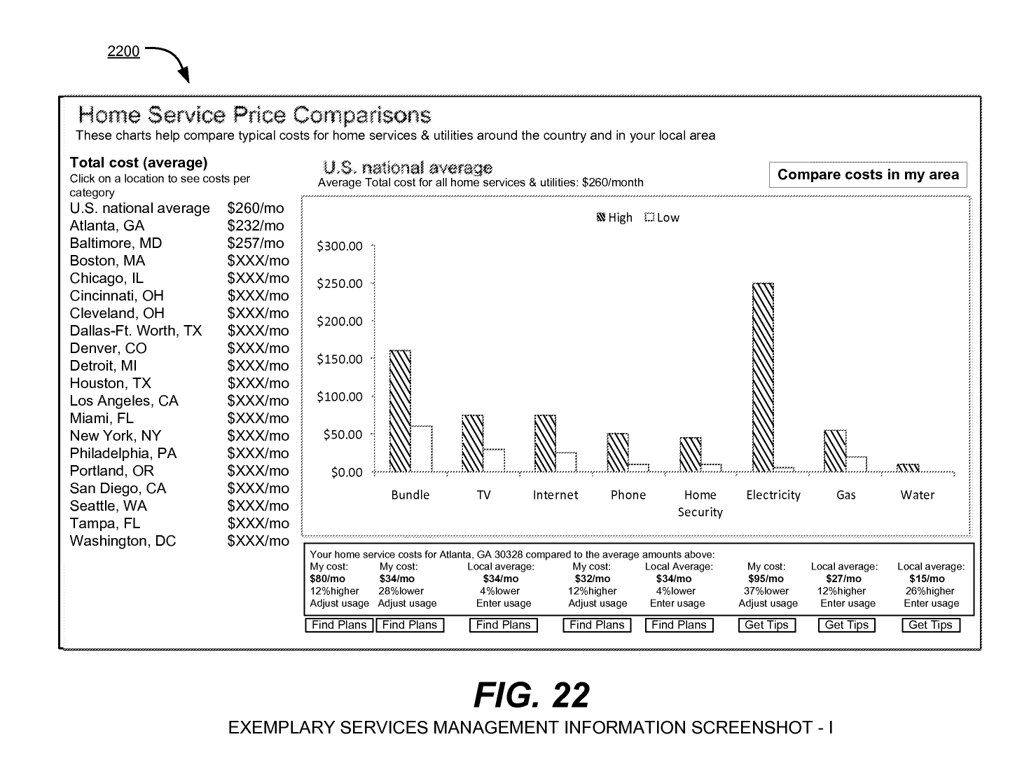

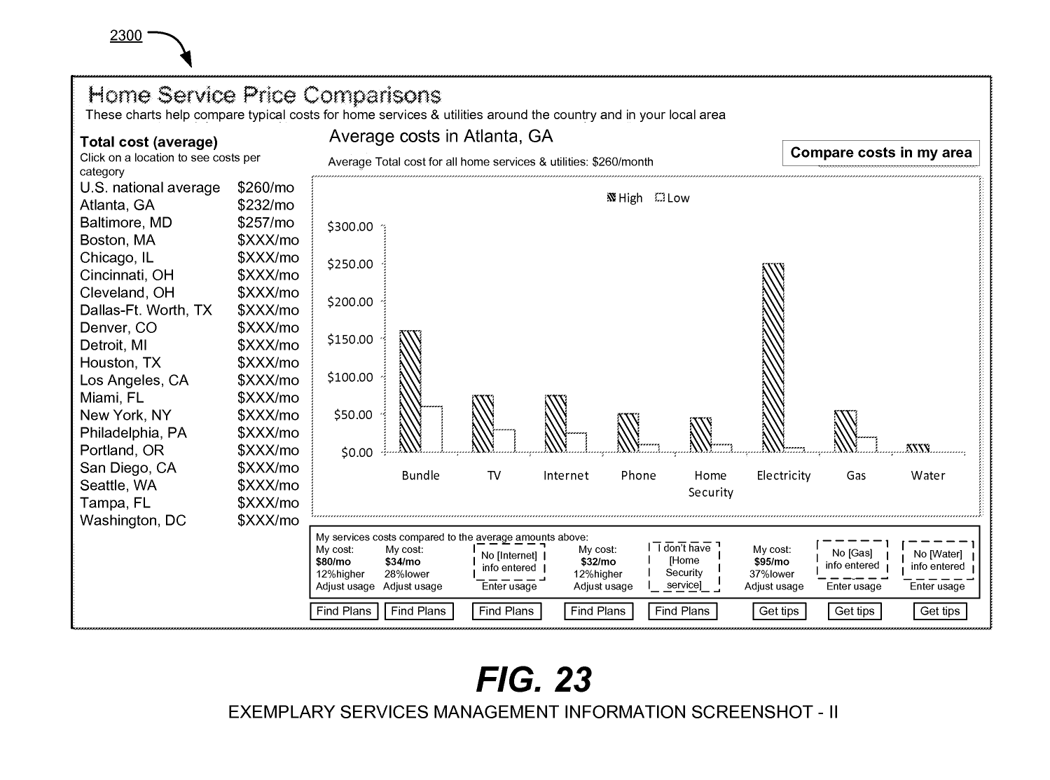

FIGS. 22-24 illustrate exemplary screen shots displaying services management information 1010 regarding a user's home services usage according to one embodiment of the present system. Specifically, FIG. 22 depicts a comparison 2200 of a given user's average monthly expenditures on his or her home services as compared to other users across the user's country (here, the U.S.). To compute this information, the advisor engine 134 not only retrieves the user's 106 service usage information and other relevant information, but service usage information for other users across the country as well. This national usage information may be retrieved based on stored information within they system databases 114, or directly from product and service provider systems 104 in real-time, or via some other information source. Next, the advisor engine 134 calculates average service usage or cost (e.g., monthly) for the given user and all other users, or calculates total expenditure for a given time period, or some other predefined statistical measure as will occur to one of ordinary skill in the art. FIG. 23 illustrates a similar display to that of FIG. 22, but provides a comparison of a user's average monthly expenditures on his or her home services as compared to other users in the given user's neighborhood or locality (here, city of Atlanta).

Further, according to one embodiment, the advisor engine retrieves user information, address information, user preference information, service configuration information, and other relevant information to calculate tailored service management information for the given user 106. For example, if, based on previously-supplied usage information, the advisor engine 134 is aware that a given user resides at a home that is 3,500 square feet in size, has 5 members of his family, and uses certain services with certain user preferences, then the advisor engine 134 can perform a comparison of the user's services to other users that have similar attributes. In this way, a user is compared to other users that should exhibit similar usage patterns, thus providing more insightful and detailed services management information 1010. For example, it may be of little use to compare the average electricity or water usage of a user residing in a large him with many occupants to a user residing in a one-bedroom apartment and no other occupants, as the water and electricity usage of these two users will typically vary greatly. Further, because the computing system 102 stores information (or is able to retrieve information) relating to each user's service preferences or configurations, a user can compare very specific usage criteria to other users. For example, a given user with a mobile phone minutes plan of 1200 minutes per month may wish to compare himself to other users with the same plan to identify how frequently those users exceed their monthly minutes as compared to how frequently the given user exceeds his minutes threshold. As will be understood and appreciated, virtually any data relating to users, their service plans, their service usage, etc., can be analyzed, compared, and provided to a user as services management information 1010. Accordingly, because the computing system 102 includes highly-specific and personalized information for each system user, highly-tailored service management information can be provided.

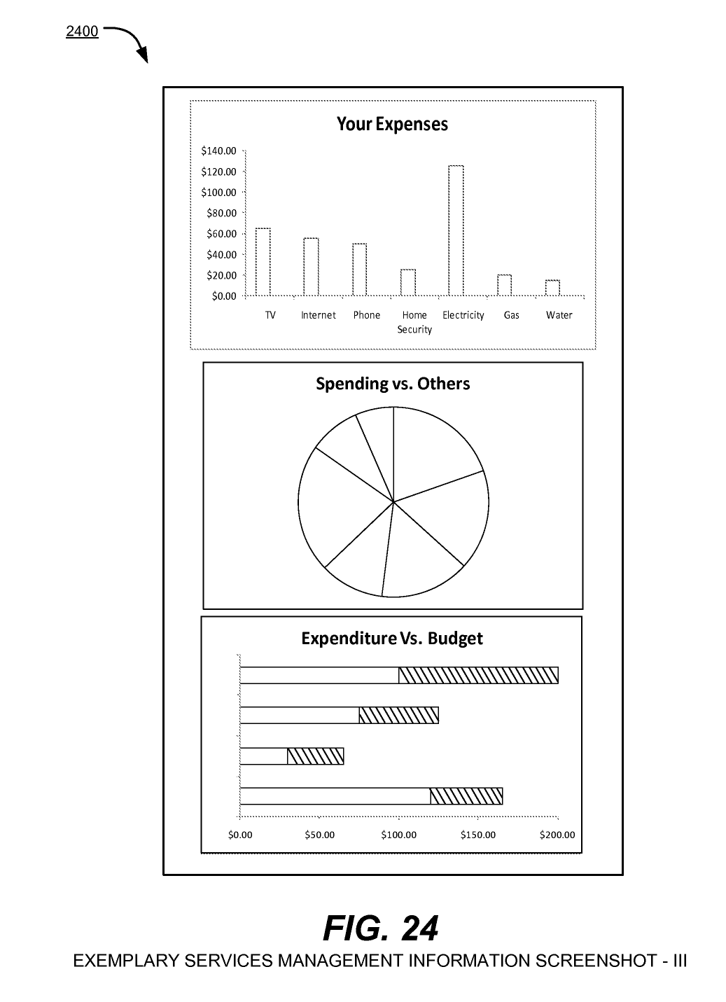

FIG. 24 illustrates another exemplary screen shot 2400 displaying services management information 1010 regarding a user's home services usage according to one embodiment of the present system. As shown, the information may include bar graphs, pie charts, etc. detailing a given user's 106 product or services expenses, his or her spending (or usage) versus other users, his or her monthly (or yearly, or current) expenditure versus a predetermined budget amount, etc. It will be understood and appreciated that the displays in FIGS. 22-24 are merely exemplary illustrations and similar pictorial or textual management information 1010 is provided in other system embodiments as contemplated by a person skilled in the art without departing from the scope of the present disclosure. In one embodiment, the analyzer 1002 utilizes mathematical formulae and equations, algorithms, and other proprietary processes to conduct a host of statistical analyses on retrieved information to generate the services management information 1010. In one embodiment, a look-up table or a database includes all the equations or formulae required for these calculations, which may be retrieved as and when required. In another embodiment, a system processor performs looped, iterative information retrievals and calculations to provide requested information to a system user.

According to one embodiment, a user may only desire or request services management information 1010, and thus process 1100 stops at step 1412. In other embodiments, however, either in addition to or in lieu of services management information, a user may desire (or simply be provided with) services optimization information generated via the advisor engine 134 (step 1414). As mentioned previously, services optimization information 1012 includes product and service recommendations (i.e., different service plans or changes to current plans to minimize service cost), helpful suggestions or hints for reducing or optimizing service usage, links to providers of goods and services (e.g., sellers of energy-efficient appliances), and so forth. Thus, at step 1414, the advisor engine 134 generates services optimization information 1012, as described below.

Generally, the services optimization information 1012 is broadly divided into two categories—recommended products or services for purchase (e.g., new service offerings, suggested service transfers, etc.), and information related to optimizing current services (e.g., energy saving tips). Regarding recommended products or services, the advisor engine 134 is able to monitor and compare, either initially, continuously, or periodically, various products and services offered by product and service providers 104 connected to the facilitation service 100, and recommend products and services to a consumer 106 that most fit the consumers needs. Because the computing system 102 includes information about the user 106, the user's current services, the user's preferences for those services, and product and service features associated with other services, the engine 134 is able to identify product and service offerings that fit the user's preferences, but that may be offered at a lower cost (or include additional features for the same cost as the user's current service, etc.). For example, in a given customer location, telephone service, cable service, and Internet service may each be provided by a number of different service providers 104, each offering a variety of service plans. In these situations, the recommendation engine 1004 may compare the plans offered by all of these providers and then provide various personalized product or plan recommendations that can help the user save money.

For example, assume a customer 106 is currently using a Telco service plan for $60/month that allows the user to make unlimited local and international calls, includes “call waiting”, but does not include caller ID. By continuously (or periodically) monitoring new service plans that become available from other product or service providers 104, the advisor engine 134 (and, specifically, the recommendation engine 1004) can alert the user to a new plan offered by a different provider that is less expensive than the user's current plan. Further, embodiments of the present system can make intelligent recommendations based on identified patterns in the use of a user's products or services. For example, the recommendation engine 1004 may identify that, based on the user's monthly phone bills, the user rarely (or never) makes international calls, but instead makes a considerable number of local calls. In this case, the recommendation engine 1004 may recommend a service plan with a lower monthly rate, but a per-minute additional charge for international calls. In this way, the user can decide whether the new plan makes sense for him or her, and if so, automatically sign up for the new plan that enables the user to save money and use his or her telephone service more efficiently.

In a further embodiment, based on user preferences, user budget, and product ratings, the recommendation engine 1004 can provide a ranked list of recommended services to the user. To this end, the recommendation engine 1004 may assign configurable or predefined weights to various characterizing parameters associated with the services, user preferences, and other such information to obtain a final list of recommendations for each service type, or for the requested service type. For example, if a user has previously indicated a strong preference for cable service that includes movie channels, the advisor engine 134 can recommend cable television plans that, even though may be more expensive than the user's current plan, include drastically better movie channels and options. According to one embodiment, an ordered output list (or ranking, or selectable icon, etc.) is provided to the user for further action. Based on the personalized list of recommendations, the user may select services or products to acquire or purchase. Additionally, as described, the ranked list may be used by a customer service representative interacting with the user to suggest optimal products or services to the user. Or, the optimal or highest ranked product or service can be automatically ordered or selected by the user. As will be understood, the recommended product or service (or list of products or services) can be used in a variety of ways as will occur to one of ordinary skill in the art.

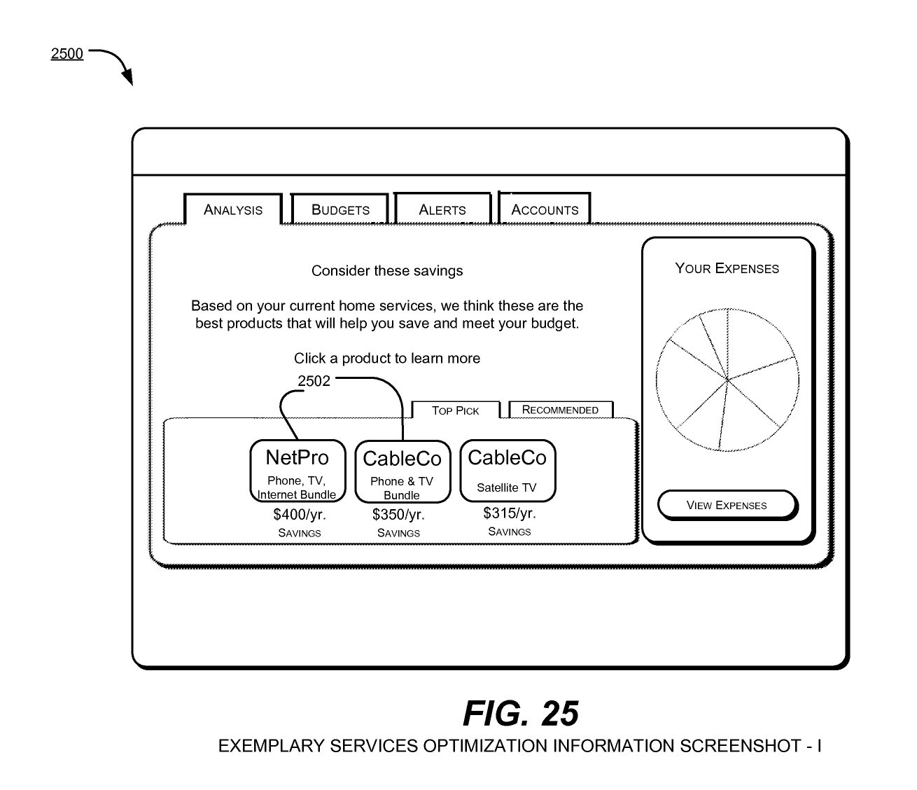

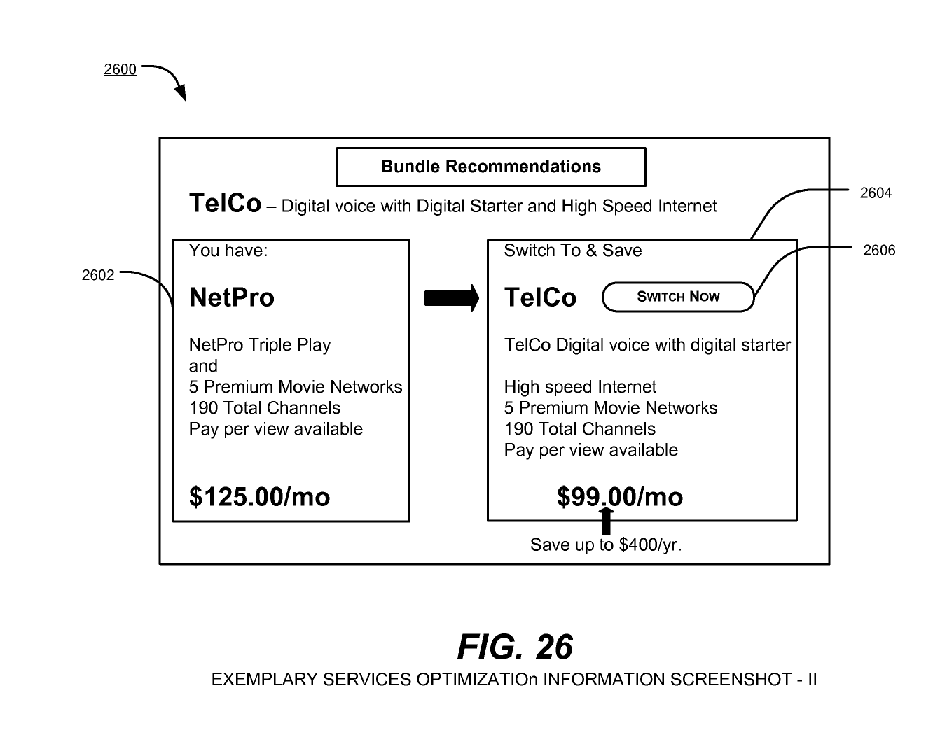

FIGS. 25-26 illustrate exemplary screenshots 2500, 2600 depicting service optimization or recommendation information 1012 according to one embodiment of the present system. FIG. 25 illustrates an example of three recommended service plans for “bundled” services, as well as potential monetary savings to the consumer. The potential savings information is generally calculated based on a user's current services expenses as compared to the expenses associated with a given product or service over a given time period. As shown, the user can “click” on the selectable icons 2502 for each service to find out more information about the service. Further, the advisor engine 134 may provide a “top pick” service that is most recommended based on the user's preferences, address details, current service usage, etc. Alternatively, an embodiment of the advisor engine 134 may present a list of “recommended” services from which the user can select.

FIG. 26 illustrates a screenshot 2600 of optimization information 1012 that is configured to allow a user 106 to automatically switch one of his or her products or services. Specifically, FIG. 26 illustrates a field 2602 that lists the user's current “bundled” services, and the service configurations associated with same (i.e., “5 Premium Movie Networks”, “190 Total Channels”, and “Pay Per View Available”). Field 2604 illustrates a recommended service plan for the user to switch to, based on a comparison of the user's current service and other service plans maintained in the products and services database 120 (or retrieved in real time from a product and service provider). As shown, the recommended plan includes all of the same features or configurations as the user's current plan, but is $26 cheaper per month. The screen 2600 also includes a “switch now” button 2606 that, when selected by a user, enables automatic registration of the user for the recommended “TelCo” service, and cancellation of the user's current “NetPro” service. As will be understood, this automatic transfer is accomplished based on pre-stored information about the user and the user's address, as well as operative connections to service provider systems, that enable seamless purchasing and cancelling of products and services. In another embodiment, the service transfer (or initial purchase) can be carried out manually by a system operator or customer service representative.

Referring again to FIG. 14 and step 1414, as mentioned previously, services optimization information 1012 also includes information relating to optimizing current products or services. For example, in some instances, only one service provider may be active at a given geographic location (e.g., there is only one water or electricity provider in a given state). Or, a user may simply not be interested in switching services. In these situations, the recommendation engine 1004 is able to provide not only recommendations for new products or services, but also information relating to efficient use of current services. For example, the advisor engine 134 may provide energy saving tips and recommendations, such as adding insulation to one's home, converting to solar heaters, using compact fluorescent light (CFL) fixtures for indoor lights, etc. According to one embodiment, the advisor engine identifies helpful information for optimizing services based on information previously supplied by the user relating to the user's address, or based on information pulled from publicly available databases (e.g., tax records, city real estate records, etc.). For example, if the system 102 identifies that the user's appliances are more than 10 years old, the advisor engine 134 may recommend that the user upgrade to newer, energy-efficient appliances. Alternatively, if the system 102 identifies that, based on the user's home size and number of occupants, the water usage for the user's address is higher than an average (or predefined threshold) for similar users with similar homes, then the advisor engine 134 may recommend tips for reducing water usage, such as taking quicker showers, only running a clothes washer when full loads are available, etc. In this way, the advisor engine 134 provides intelligent information regarding optimizing usage of products and services based on individualized user information.

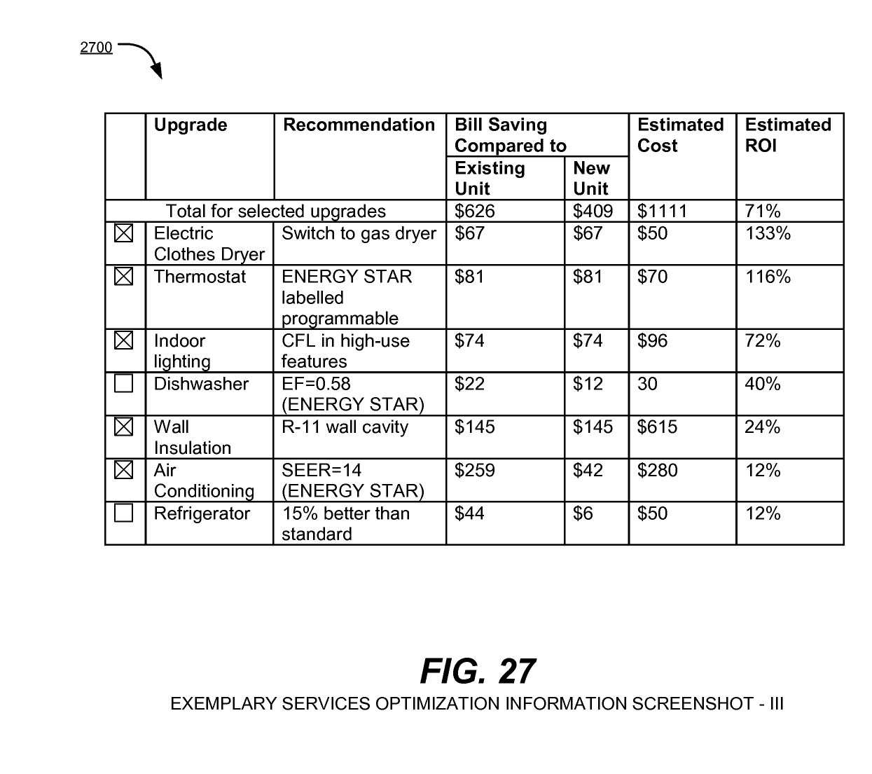

FIG. 27 illustrates an exemplary screenshot 2700 services optimization information relating to a user's current products or services and upgrades that can be made to those services for more efficient use and cost savings. Specifically, FIG. 27 shows electricity saving recommendations for a user based on his or her location, current electricity bill, dwelling type, number of rooms, number of occupants in the dwelling, and other such information. Additionally, as shown in FIG. 27, one embodiment of the recommendation engine 1004 provides estimated costs to follow through with the recommended energy saving tips, approximate return on investments, and other such information that may be important for a customer while considering changing or updating current dwelling conditions. As will be understood and appreciated, embodiments of the present system can provide a variety of information relating to a user's home services or products based on specifics associated with the user's address, product or service usage, user preferences, and so on.

As mentioned previously, according to some embodiments of the present system, a user 106 is able to establish alerts or notifications 1018 relating to various aspects of the user's services, or when certain products or services at certain price points become available, etc. For example, alerts may be set for advising a user when usage thresholds are exceeded, when any irregularities in usage patterns are detected, for payment deadlines, contract expiry notifications, new promotions, sales, new deals, service outages, introduction of a new service type in the user's locality, and other such alerts. For example, a user may request that a customer service representative call the user whenever the user exceeds the allowed number of SMS “text message” associated with the user's mobile phone plan set by the provider. As another example, if a user orders a number of pay-per-view movies in the month, the advisor engine 134 may alert the user via SMS, email, phone, etc., that a number of pay-per-view movies have been charged to the user and ordering any more movies can increase the user's television bill beyond a set monthly cable budget. It will be understood that any number of examples and instances can be contemplated where users may benefit from such alerts and notifications. As another example, the user may configure the advisor engine 134 to alert the user of new recommended plans or services that meet certain predefined requirements, such as if the bill savings from such a plan would be higher than $50 per year, or alert the user only about new service plans from his or her current service provider 104 that can help save more than $20 a month.

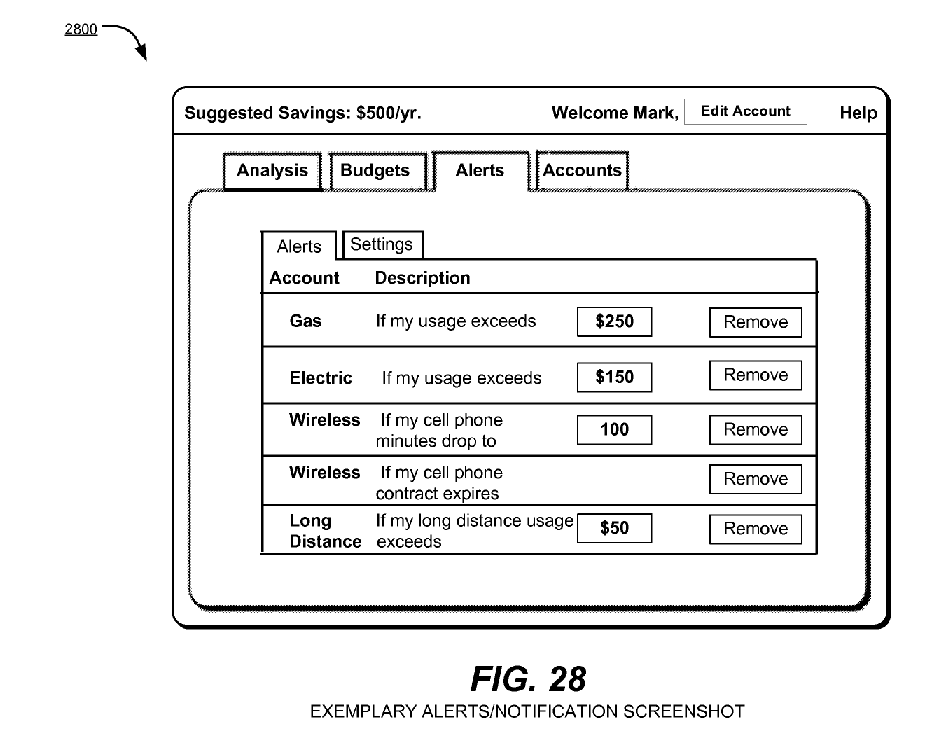

FIG. 28 illustrates an exemplary screenshot 2800 depicting a number of configurable alerts established by a user 106 relating to the user's product or service usage. As shown, the user has indicated a request for an alert if his or her gas or electric service exceeds a certain monetary amount, or if the user's available cellular phone minutes falls below a given amount, or if the user's cellular phone plan is about to expire, etc. As will be understood, users may add or remove alerts at any time by logging onto the advisor engine 134 and configuring their accounts. As will also be understood and appreciated, virtually any alerts relating to a user's products or services can be utilized as will occur to one of ordinary skill in the art according to various system embodiments.

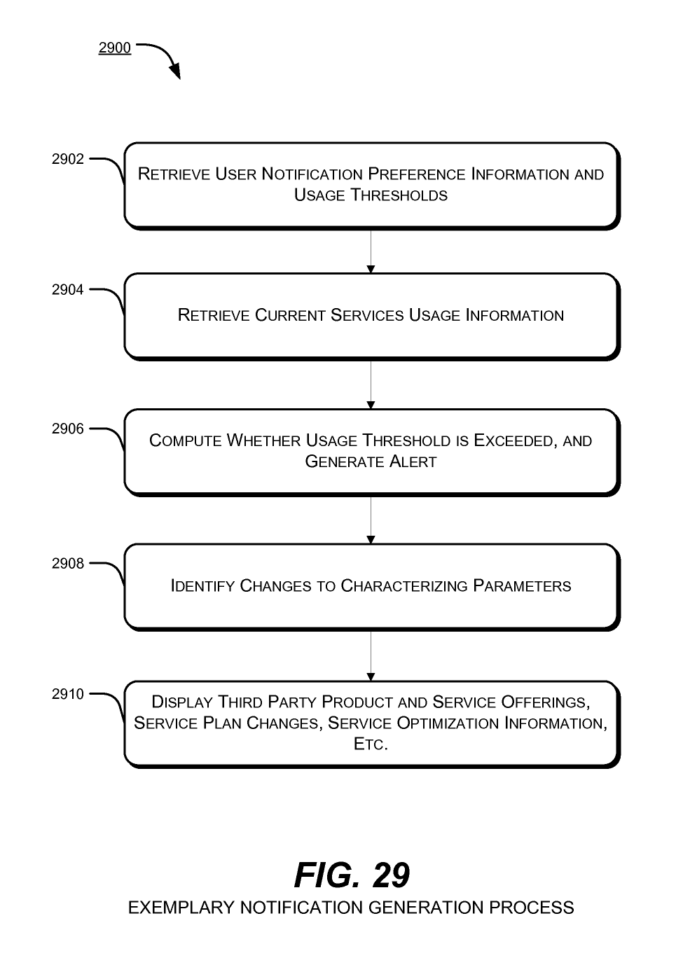

FIG. 29 is a flow chart 2900 illustrating an exemplary method for alerting or notifying a user regarding an issue relating to the user's products or services. As will be understood, the flow chart shown in FIG. 29 is presented for illustrative purposes only, and other processes and methods may be implemented by embodiments of the present system to facilitate generation and transmission of various alerts to system users 106. For example, other notification methods may be implemented to alert users when new service plans become available that meet the user's predetermined preferences. The method 2900 generally includes the steps of retrieving user notification preference information relating to the user's predetermined alerts and service usage thresholds, retrieving service usage information for the user's products and services, computing whether usage thresholds have been exceeded and generating corresponding alerts, identifying changes to characterizing parameters in various third party products and services (e.g., new service plans that may meet the user's needs), and displaying third party providers involved in parameter changes, exceeded usage, plan change, or new service offerings.

According to the embodiment shown, at step 2902, the notification module 1014 retrieves user notification preference information and usage thresholds (e.g., predetermined thresholds set by a user or defined by a system operator, real-time threshold requests, etc.). In one embodiment, this information can be retrieved from users directly in real-time through the user interface 126. Alternatively, the user (or system operator) may specify this information while setting up the account, and the information may be stored in the customer database 116. According to one embodiment, user notification information may include information such as whether notification is required, service type corresponding to the alert, type of alert, mode of notification (email, phone, SMS), etc. Usage thresholds may include numbers, “yes” or “no” type of values against service configuration information, or against characterizing parameters. For example, a usage threshold can be $50 for minimum savings, 50 minutes for international calling minutes, or “yes” for a service notification—e.g., “alert me when new gas services are introduced in my locality,” and so on.

At step 2904, the notification module 1014 retrieves current service usage information for all services for which notifications are required. This information may be retrieved from the service provider 104 directly, or from the customer information database 116. For example, daily or latest usage updates may be retrieved directly from the service provider systems 104, while contract expiry dates or bill due dates may be retrieved from the customer information database 116.

At step 2906, the notification module 1014 determines whether the usage thresholds configured by the user have been exceeded by comparing the usage thresholds (or other alert notifiers) to service usage information. Consider an exemplary notification for cell phone usage exceeding $50—the notification module 1014 regularly (e.g., hourly or daily or continuously) checks the user's cell phone usage until the user's cell phone usage exceeds $50. At that point, the notification module 1014 generates an alert 1018, checks the mode of notification requested by the user 106, and sends the alert to the user using the preferred mode of notification. Based on this information, the user may curb his or her cell phone usage, thereby preventing a large and unexpected cell phone bill at the end of the month.

According to one embodiment, process 2900 ends at step 2906, after one or more alerts have been generated and provided to a user 106 (or, whether a determination has been made that no alerts are necessary at this time). As described previously, however, the notification module 1014 may also be utilized to generate notifications (and send the same to system users 106) about new, updated, or different service recommendations based on one or more predetermined rules. To this end, process 2900 continues to step 2908, and the advisor engine 134 identifies changes to the characterizing parameters associated with various third party products and services. As will be understood, because the computing system 102 includes user preference information, information relating to a user's address or location(s), characterizing parameter information of third party products and services, and so on, the system can identify and retrieve new or different product or service offerings that may fit a user's specific needs and/or preferences.

In one embodiment, the notification module 1014 monitors only the characterizing parameters that are involved in a configured notification, whether configured by a user 106 or system operator. For example, if a notification has been configured to advise a user of any telephone, Internet, and TV “bundle” service plan available in the user's locality, with a monthly plan value lower than $150, then the notification module 1014 only monitors the price characterizing parameter of bundle service plans in the user's geographic area. Thus, whenever a product or service provider 104 releases or offers a bundle service plan with a value lower than $150, the notification module 1014 identifies such plan and displays the third party service plan information to the user using the preferred notification method at step 2910 (e.g., via an alert, or during an on-line session conducted by the user, etc.). As another example, a user may define a notification to occur whenever a product or service offering is detected that includes all of the user's predefined preferences, but is offered at a price that is lower than the current price of the user's current service offering for that type of service.

It will be understood and appreciated that the notification module 1014 may be utilized for setting up any number, type, or complexity of alerts without departing from the scope of the present disclosure. Examples of alerts 1018 include changes in characterizing parameters associated with new or different product or service offerings, change in usage patterns of a user's service(s), usage in excess of set budget or threshold values, plan changes, plan expiry dates, contract renewal dates, bill payment dates, limited time promotions, sales, and other such alerts. It will be further understood that the alerts listed above are merely exemplary, and are not intended to limit the scope of the type of alert that may be contemplated in the scope of the present disclosure. Further, the embodiment of the notification process 2900 illustrated in FIG. 29 may be run on a continuous loop (i.e., to continuously check for new product or service offerings, identify alert situations, etc.), or periodically, or on an “on demand” basis (e.g., each time a user logs in to the computing system 102 to access his or her accounts).

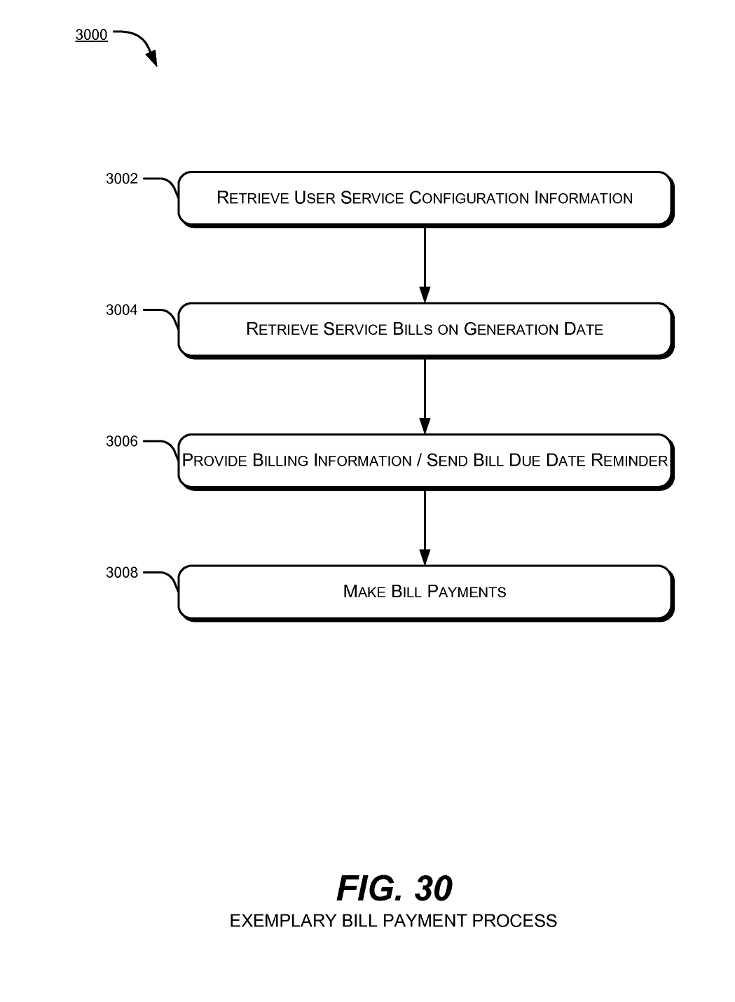

FIG. 30 is a flow chart illustrating an exemplary bill payment method 3000 for paying bills associated with third party product and service providers 104. The method begins at step 3002, where the bill payment module 1016 retrieves service configuration information corresponding to a user 106 from the customer information database 116. Alternatively, the bill payment module 1016 can directly retrieve this information from the user's third party service providers 104 via operative connections with third party provider systems.

Next, at step 3004, the bill payment module 1016 retrieves billing information from the third party service providers on the bill generate dates. The bill generation date may be obtained from the service configuration information. The billing information generally includes all of the information that would be provided to the user if the service provider 104 were to issue the bill directly to the user (e.g., amount, due date, service usage information, additional charges, etc.). The retrieved bills may be provided to the user using a preferred notification mode. For example, electronic billing information may be generated and sent to a user 106 via email. Alternatively, a user may simply log in to the online system 102 via the interface 126 to view pending bills, recently-paid bills, etc.

At optional step 3006, the bill payment module 1016 may utilize the notification module 1014 to send bill payment due date reminders to the user 106. Alternatively, the bill payment module 1016 may include its own reminder module to send out the bill payment reminders.

If the user 106 has authorized the bill payment module 1016 to pay bills automatically, the module may not send bill payment reminders to the users, and instead send acknowledgement receipts for bill payment. At step 3008, the bill payment module 1016 makes due payments 1020. This transaction may be completed in a variety of ways. For example, if the user has provided standing instructions to the module to pay all utility bills before their due dates, the bill payment module 1016 may automatically initiate a payment process, using pre-supplied financial account information of the user. Alternatively, the user may transfer some amount of money into a separate escrow account accessible by the bill payment module 1016, and request the module to pay all bills utilizing this amount. In another embodiment, the user may be required to login to the bill payment module 1016 to manually make payments against all the service bills. As will be understood and appreciated, any payment mode may be utilized to pay user bills, such as credit cards, debit cards, electronic transfers, through bill pay, and so on, without departing from the scope of the present disclosure. Information relating to various payment methods may be previously-supplied by an account user 106, or provided at the time of payment, or retrieved automatically from a financial service provider, and so on.

Systems and methods disclosed herein may be implemented in digital electronic circuitry, in computer hardware, firmware, software, or in combinations of them. Apparatus of the claimed invention can be implemented in a computer program product tangibly embodied in a machine-readable storage device for execution by a programmable processor. Method steps according to the claimed invention can be performed by a programmable processor executing a program of instructions to perform functions of the claimed invention by operating based on input data, and by generating output data. The claimed invention may be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, and/or in assembly or machine code. The language or code can be a compiled or interpreted language or code. Processors may include general and special purpose microprocessors. A processor receives instructions and data from memories. Storage devices suitable for tangibly embodying computer program instructions and data include all forms of non-volatile memory, including by way of example, semiconductor memory devices, such as EPROM, EEPROM, and flash memory devices; magnetic disks such as internal hard disks and removable disks; magneto-optical disks; and Compact Disk. Any of the foregoing can be supplemented by or incorporated in ASICs (application-specific integrated circuits).

The specification has described an embodiment of an electronic order facilitation system that includes a services management system and/or portal (e.g., advisor engine) that enables each user to manage all or many of his or her third party products and services from one electronic platform. Specifically, the system includes operative connections to service provider systems so as to track customer usage of various third party products and services. This usage information is utilized to provide the user via the services management system with a consolidated view of the user's products and services and enable the user to track usage and expense of the services, compare the expense to predetermined budget amounts, compare the usage to other users locally and nationally, etc. Additionally, the services management system provides alerts to the users (e.g., via email, mobile phone, text (SMS) message, etc.) when certain usage or expenditure thresholds are reached (e.g., mobile phone minutes overage, pay-per-view movie orders, etc.), when payments become due, or when new offers, deals, or service promotions become available, etc. Further, the system allows for consolidated bill payment from one convenient location.

The foregoing description of the exemplary embodiments has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the systems and their practical application so as to enable others skilled in the art to utilize the systems and various embodiments and with various modifications as are suited to the particular use contemplated. Alternative embodiments will become apparent to those skilled in the art to which the present disclosure pertains without departing from their spirit and scope. Accordingly, the scope of the present inventions is defined by the appended claims rather than the foregoing description and the exemplary embodiments described therein.

1-34. (canceled)

35. In a services management computer system comprising a processor and an electronic database communicatively coupled to the processor, a computer-implemented method for optimizing third party services offered by third party service providers to users, the method comprising the steps of:
receiving at the electronic database of the services management computer system services configuration information for a particular user, the services configuration information including one or more characterizing parameters associated with one or more existing third party services utilized by the particular user;
receiving at the electronic database of the services management computer system service usage information for the particular user, the service usage information indicative of utilization of the one or more existing third party services by the particular user;
receiving at the electronic database of the services management computer system user preference information for the particular user, the user preference information indicative of one or more third party service preferences of the particular user;
receiving at the electronic database of the services management computer system services available information from one or more third party service providers corresponding to one or more available third party services that are available at a geographic location of the particular user, wherein the services available information includes one or more characterizing parameters associated with the one or more available third party services that are available at the geographic location of the particular user;
in response to a predetermined event, performing the steps of:
comparing the user preference information of the particular user to the services available information corresponding to the one or more available third party services via the processor of the services management computer system to identify a subset of the one or more available third party services whose one or more characterizing parameters satisfies at least one of the one or more third party service preferences of the particular user;
for each of the third party services in the subset of the one or more available third party services, comparing:
(i) the one or more characterizing parameters included in the services configuration information of the particular user,
(ii) the one or more characterizing parameters included in the services available information associated with the identified subset of the one or more available third party services, and
(iii) the service usage information for the particular user, to identify a respective service in the subset of the one or more available third party services that satisfies one or more pre-existing optimization criteria;
upon identification of the respective service in the identified subset of the one or more available third party services that satisfies the one or more pre-existing optimization criteria, generating services optimization information including a recommendation for the respective service for the particular user; and
providing the generated services optimization information to the particular user.

36. The computer-implemented method of claim 35, further comprising the step of, in response to the providing step, receiving information from the user relating to one or more of the following: purchase of the respective third party service, transfer of an existing third party service utilized by the particular user to the respective third party service, receiving additional service usage information associated with the respective third party service, receiving a request for additional information relating to the services optimization information, receiving additional services configuration information associated with the respective third party service.

37. The computer-implemented method of claim 35, wherein the one or more characterizing parameters are selected from the group comprising: features or options of the third party services, particular plans included with the third party services, prices of the third party services, limitations associated with the third party services, geographic areas serviced, third party service providers that offer the third party services, deals or promotions associated with the third party services.

38. The computer-implemented method of claim 35, further comprising the step of receiving user profile information from the particular user corresponding to predetermined user profile characteristics, the user profile information including user-related information and user preferences indicative of one or more delivery mechanisms of providing the services optimization information to the particular user.

39. The computer-implemented method of claim 38, further comprising the step of storing the user profile information in the electronic database associated with the services management computer system.

40. The computer-implemented method of claim 38, wherein the one or more delivery mechanisms comprise one or more of the following: a SMS message, a MMS message, an email, a phone call, online posting on an Internet-accessible portal.

41. The computer-implemented method of claim 35, wherein the generated services optimization information is associated with the one or more existing third party services previously utilized by the particular user.

42. The computer-implemented method of claim 35, wherein the generated services optimization information is associated with a new third party service for the particular user.

43. The computer-implemented method of claim 35, further comprising the step of storing the generated services optimization information in the electronic database associated with the services management computer system.

44. The computer-implemented method of claim 35, further comprising the step of providing a communications link to the one or more third party service providers for electronic communications between the services management computer system and computer systems of the one or more third party service providers.

45. The computer-implemented method of claim 35, further comprising the step of storing the services available information received from the one or more third party service providers corresponding to the one or more available third party services in the electronic database associated with the services management computer system.

46. The computer-implemented method of claim 35, wherein the predetermined event comprises one or more of: receipt of one or more new characterizing parameters included in the received services configuration information, receipt of one or more updated characterizing parameters included in the received services configuration information, receipt of one or more new characterizing parameters included in the received services available information from the one or more third party service providers, receipt of one or more updated characterizing parameters included in the received services available information from the one or more third party service providers, introduction by a third party service provider of one or more new third party services, reduction in price of one or more third party services, elimination of one or more third party services, receipt of updated service usage information for the particular user, receipt of new service usage information for the particular user, receipt of updated user preference information for the particular user, receipt of new user preference information for the particular user.

47. The computer-implemented method of claim 35, wherein the services optimization information is selected from the group comprising: expense comparisons between the respective third party service and an existing third party service of the particular user, suggestions for reducing or optimizing usage of an existing third party service of the particular user, information relating to other products and services to enhance efficiency of an existing third party service of the particular user, order history information of the particular user, product or service rankings corresponding to the one or more available third party services that are available at the geographic location of the particular user, popularity information of the one or more available third party services that are available at the geographic location of the particular user.

48. The computer-implemented method of claim 35, wherein the pre-existing optimization criteria comprises a predefined rule based on the one or more characterizing parameters, the satisfaction of which triggers the generation of services optimization information.

49. The computer-implemented method of claim 35, further comprising the step of providing an alert to the particular user, wherein the alert includes the services optimization information.

50. The computer-implemented method of claim 35, wherein the service usage information indicative of utilization of the one or more existing third party services by the particular user corresponds to a predetermined period of time.

51. In a services management computer system comprising a processor and an electronic database communicatively coupled to the processor, a computer-implemented method for offering recommendations of third party services offered by third party service providers to users, the method comprising the steps of:
receiving at the electronic database of the services management computer system services configuration information for a particular user, the services configuration information including one or more characterizing parameters associated with one or more existing third party services utilized by the particular user;
receiving at the electronic database of the services management computer system service usage information for the particular user, the service usage information indicative of utilization of the one or more existing third party services utilized by the particular user;
receiving at the electronic database of the services management computer system services available information from one or more third party service providers corresponding to one or more available third party services that are available at a geographic location of the particular user, wherein the services available information includes one or more characterizing parameters associated with the one or more available third party services that are available at the geographic location of the particular user;
in response to a predetermined event, performing the steps of:
comparing:
(i) the one or more characterizing parameters associated with the one or more existing third party services utilized by the particular user and included in the services configuration information,
(ii) the one or more characterizing parameters associated with the one or more available third party services and included in the services available information, and
(iii) the service usage information for the particular user,
to identify at least one respective service in the one or more available third party services that satisfies one or more pre-existing optimization criteria; and
upon identification of the respective service that satisfies the one or more pre-existing optimization criteria, generating one or more recommendations for the respective service for selection by the particular user.

52. In a services management computer system comprising a processor and an electronic database communicatively coupled to the processor, a computer-implemented method for managing services offered by one or more service providers to users, the method comprising the steps of:
retrieving from the electronic database a user profile for a particular user, wherein the user profile includes services information corresponding to one or more services utilized by the particular user and service usage information indicative of utilization of each of the one or more services utilized by the particular user;
receiving one or more predefined usage thresholds at the services management computer system associated with each of the one or more services utilized by the particular user;
for each of the one or more services, analyzing via the processor of the services management computer system the service usage information and the associated one or more predefined usage thresholds to identify at least one respective service whose usage exceeds at least one of the one or more predefined usage thresholds;
upon identification of the at least one respective service that exceeds at least one of the one or more predefined usage thresholds, generating services optimization information for the at least one respective service,
whereby the generated services optimization information is used to assist the particular user in efficient utilization of the at least one respective service.

53. The computer-implemented method of claim 52, wherein the one or more predefined usage thresholds associated with each of the one or more services corresponds to usage criteria relating to other users having similar user profiles as the particular user.
